(19) United States
(12) Patent Application Publication
(10) Pub. No.: US 2006/0114762 A1
(43) Pub. Date: Jun. 1, 2006

(54) Contents data structure, contents data recording medium and contents data recorder

(75) Inventor: Yuichi Kanai, Ichinomiya-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/289,719

(22) Filed: Nov. 30, 2005

(30) Foreign Application Priority Data
Nov. 30, 2004 (JP) P2004-347647

(51) Int. Cl. G11B 7/085; G11B 21/08

(52) U.S. Cl. 369/30.09

(57) ABSTRACT

In a contents data recording medium according to the present invention, a plurality of pieces of contents data are recorded as individual files. The contents data recording medium includes: link information which indicates at least positions and sizes of the contents data on the contents data recording medium; metadata which describes contents of the contents data and is used for retrieval of the individual files; and a management file which includes the link information and the metadata. By use of the management file, an access device which accesses the contents data recording medium retrieves the contents data.

### CROSS REFERENCE TO RELATED APPLICATIONS

This application is based upon and claims the benefit of priority from the prior Japanese Patent Applications No. P2004-347647, filed on Nov. 30, 2004; the entire contents of which are incorporated herein by reference.

### BACKGROUND OF THE INVENTION

1. Field of the Invention

The present invention relates to a contents data structure, a contents data recording medium and a contents data recorder, in the case where each piece of contents data is recorded as an individual file.

2. Description of the Related Art

As a format for recording contents data such as audio data in a removable recording medium such as a CD-R and a DVD, a Universal Disk Format (UDF) has been widely used.

Moreover, there have also been established standards of a secure UDF (for example, “secure UDF standards 1.00 version”) for providing functions related to ensuring of security such as access control for protecting intellectual property rights (for example, copyright) for contents data recorded in a removable recording medium by extending the UDF.

### BRIEF SUMMARY OF THE INVENTION

In the secure UDF, various specifications concerning ensuring of security such as encoding have been defined. However, regarding convenience for a user who handles contents data recorded in a removable recording medium, there is still much to be improved.

The present invention was made in consideration of the foregoing circumstances. It is an object of the present invention to provide a contents data structure, a contents data recording medium and a contents data recorder, all of which can improve convenience in handling contents data such as audio data recorded in a removable recording medium.

In order to solve the above problems, the present invention has the following aspects. First, a first aspect of the present invention is a contents data structure used in a contents data recording medium in which a plurality of pieces of contents data are recorded as individual files. The contents data structure includes: a link information segment which indicates at least positions and sizes of the contents data on the contents data recording medium; a metadata segment which describes contents of the contents data and is used for retrieval of the individual files; and a management file area which includes the link information segment and the metadata segment. By use of the management file area, an access device which accesses the contents data recording medium retrieves the contents data.

A second aspect of the present invention according to the first aspect of the present invention is that the management file segment includes a license management information segment which allows the access device to play the contents data.

A third aspect of the present invention is a contents data recording medium in which a plurality of pieces of contents data are recorded as individual files. The contents data recording medium includes: link information which indicates at least positions and sizes of the contents data on the contents data recording medium; metadata which describes contents of the contents data and is used for retrieval of the individual files; and a management file which includes the link information and the metadata. By use of the management file, an access device which accesses the contents data recording medium retrieves the contents data.

A fourth aspect of the present invention according to the third aspect of the present invention is that the management file includes license management information which allows the access device to play the contents data.

A fifth aspect of the present invention is a contents data recorder which records a plurality of pieces of contents data as individual files. The contents data recorder includes: a link information generation unit for generating link information which indicates at least positions and sizes of the contents data on the contents data recording medium; a meta-information acquisition unit for acquiring metadata which describes contents of the contents data and is used for retrieval of the individual files; a management file generation unit for generating a management file which includes the link information and the metadata; and a contents retrieval unit for retrieving the contents data by use of the management file.

A sixth aspect of the present invention according to the fifth aspect of the present invention is that the management file includes license management information which allows playback of the contents data, and the contents data recorder further includes a contents playback unit for playing the contents data based on the license management information.

According to the aspects described above, a user who utilizes contents data (for example, audio data such as music contents) can more easily and promptly retrieve and play the contents data by use of a management file including link information and metadata (for example, titles and artist names of the music contents). Thus, convenience in handling the contents data is improved.

Specifically, according to the aspects of the present invention, it is possible to provide a contents data structure, a contents data recording medium and a contents data recorder, all of which can improve convenience in handling contents data such as audio data recorded in a removable recording medium.

### BRIEF DESCRIPTION OF THE DRAWINGS

FIG. 1 is a schematic view of a file format according to an embodiment of the present invention.

FIG. 2 is a block diagram of directories and files according to the embodiment of the present invention.

FIG. 3 is a block diagram of AUD_SET.MGR according to the embodiment of the present invention.

FIG. 4 is a block diagram of an AUDxxxxxxx.AIF file according to the embodiment of the present invention.

FIG. 5 is a view showing a model configuration example using “Track_Base” according to the embodiment of the present invention.

FIG. 6 is a view showing a model configuration example using “Preset_Track_Base” according to the embodiment of the present invention.

FIG. 7 is a view showing a state before acquisition (purchase) of a license of encoded music contents in the model configuration example according to the embodiment of the present invention.

FIG. 8 is a view showing a state after acquisition (purchase) of a license of encoded music contents in the model configuration example according to the embodiment of the present invention.

FIG. 9 is a view showing a basic configuration example of a music contents management model according to the embodiment of the present invention.

FIG. 10 is a view showing a configuration example in the case where music albums are managed in the embodiment of the present invention.

FIG. 11 is a view showing a configuration of a music recorder (a contents data recorder) according to the embodiment of the present invention.

FIG. 12 is a view showing an operation flow of the music recorder according to the embodiment of the present invention.

FIG. 13 is a view showing the operation flow of the music recorder according to the embodiment of the present invention.

FIG. 14 is a view showing the operation flow of the music recorder according to the embodiment of the present invention.

FIG. 15 is a view showing the operation flow of the music recorder according to the embodiment of the present invention.

FIG. 16 is a view showing the operation flow of the music recorder according to the embodiment of the present invention.

FIG. 17 is a view showing the operation flow of the music recorder according to the embodiment of the present invention.

FIG. 18 is a view showing the operation flow of the music recorder according to the embodiment of the present invention.

FIG. 19 is a view showing the operation flow of the music recorder according to the embodiment of the present invention.

FIG. 20 is a view showing the operation flow of the music recorder according to the embodiment of the present invention.

FIG. 21 is a view showing the operation flow of the music recorder according to the embodiment of the present invention.

FIG. 22 is a view showing the operation flow of the music recorder according to the embodiment of the present invention.

FIG. 23 is a view showing the operation flow of the music recorder according to the embodiment of the present invention.

FIG. 24 is a view showing the operation flow of the music recorder according to the embodiment of the present invention.

FIG. 25 is a view showing the operation flow of the music recorder according to the embodiment of the present invention.

FIG. 26 is a view showing a model configuration for explaining a sort operation for track links executed in the music recorder according to the embodiment of the present invention.

### DESCRIPTION OF THE PREFERRED EMBODIMENTS

Next, with reference to the drawings, an example of an embodiment of the present invention will be described. Note that, in the following description of the drawings, the same or similar parts will be denoted by the same or similar reference numerals.

### (Contents Data Structure According to Embodiment)

First, description will be given of a contents data structure according to this embodiment, to be more specific, an overview of a file format, a directory structure and each file structure, which are used in the case where music contents (audio data) are stored in a removable recording medium such as a hard disk, a rewritable optical disk and a memory card.

(1) Overview of File Format

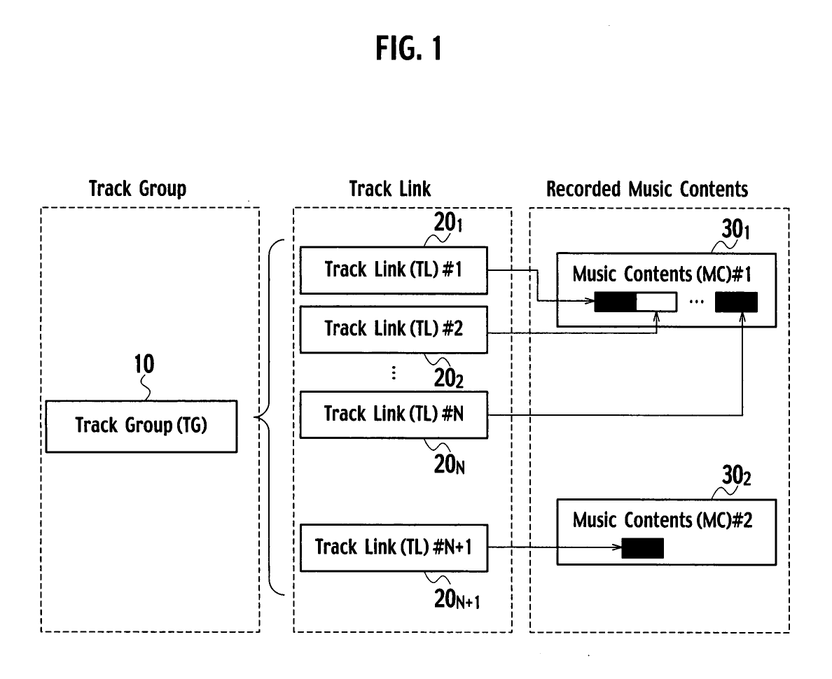

FIG. 1 shows a schematic view of a file format (audio format) according to this embodiment. “Recorded music contents” (hereinafter abbreviated as MC) are the entity of music contents stored in the removable recording medium.

(1.1) Recorded Music Contents

MC30₁ and 30₂ are contents which are obtained by ripping a CD or are delivered via a communication network.

MC30₁ and 30₂ may be formed of one song or a plurality of songs in terms of music. A unit, so-called a “music album,” can also be expressed by one MC. Note that in this embodiment, a “track” is formed of one song, and the “music album” is formed of a plurality of songs.

Moreover, MC30₁ and 30₂ include not only music contents but also metadata (song titles, artist names and the like) of the music contents.

Furthermore, in the case where the music contents are encoded, MC30₁ and 30₂ include a content key for decoding the encoded music contents and information indicating relevance to a license file which describes conditions for utilization of the music contents and the like. Note that, as a matter of course, the music contents (audio data) included in MC30₁ and 30₂ can be also recorded in the removable recording medium in a compressed state.

(1.2) Track Link

A “track link” (hereinafter abbreviated as TL) is link information (track link information) on one song in the MC. Each of TL20₁ to 20_{N+1} enables access to music contents by one song. Moreover, besides the track link information to MC30₁ and 30₂, TL20₁ to 20_{N+1} have an ID of the TL, metadata for search and display by a user, resume information which records location of music contents last played, link count information which records the number of links from a “track group” to be described later, and the like.

(1.3) Track Group

A “track group” (hereinafter abbreviated as TG) is an aggregate of TLs (expressed by a list of TLs) or an aggregate of TGs (expressed by a list of TGs).

TG10 expressed by the aggregate of TLs is differentiated into the case where the order of the list has a meaning and the case where the order thereof has no meaning. For example, a “music album,” a “playlist” in which a user's favorite songs are collected or the like has a meaning in the order of the list. Note that the playlist can be freely created by the user and is formed of a list of a plurality of songs.

Meanwhile, in the case where TG10 is a “basic track set” which manages all songs recorded in a removable recording medium, the order of the list has no meaning. Moreover, the TG expressed by the aggregate of TGs has no meaning in the order of the list. As an example of using the TG, there is a top playlist in which playlists are collected, or the like.

In the TG, a group list and an ID of the TG are recorded. Moreover, if the order of the list has a meaning, resume information and the like are recorded therein.

(2) Directory/File Structure

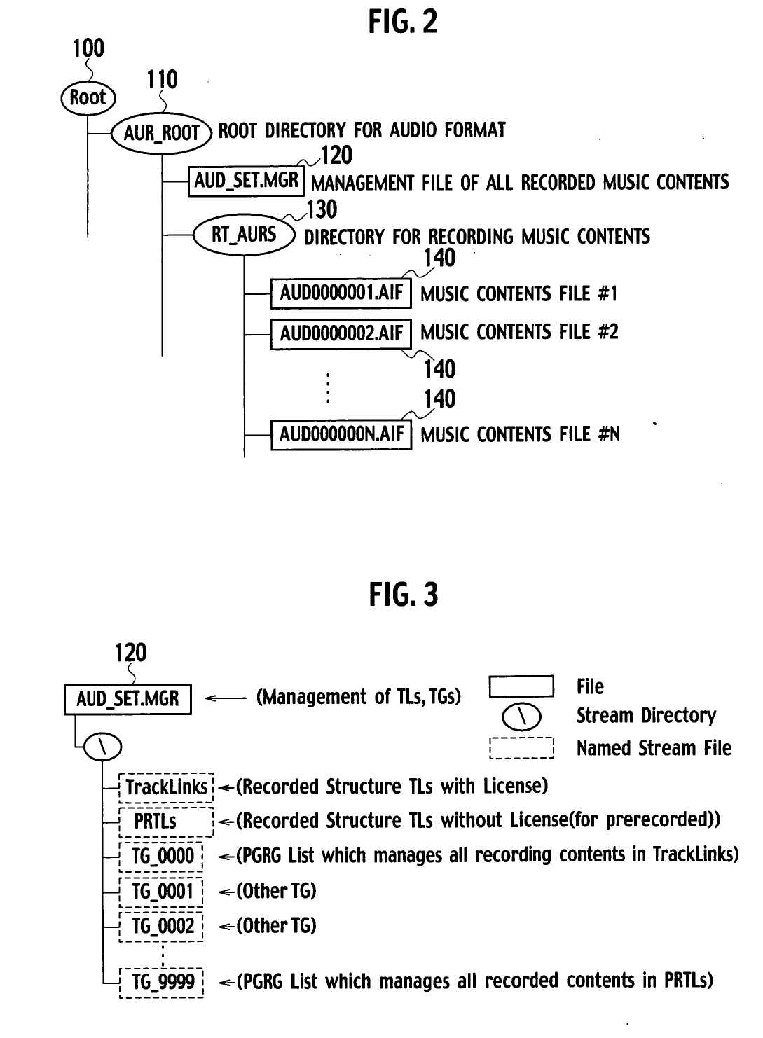

FIG. 2 shows directories and a file structure (file system) which are used in this embodiment. Note that, in this embodiment, as the file system, a secure UDF is used.

AUR_ROOT directory 110 is positioned under ROOT directory 100 and is a root directory of an application for recording music contents (audio data) in a removable recording medium, in other words, a root directory for an audio format.

AUD_SET.MGR120 is a file which manages all music contents already recorded in the removable recording medium. Note that, in AUD_SET.MGR120, the TL and TG described above are also managed.

RT_AURS directory 130 is a directory in which the entity of music contents is recorded. Specifically, an AUDxxxxxxx.AIF file 140 is the entity of music contents. In “xxxxxxx,” a 7 digit (0000000 to 9999999) number (ASCII code) is described.

(3) Structure of AUD_SET.MGR

FIG. 3 shows a structure of AUD_SET.MGR. Some stream files defined by the UDF are attached to AUD_SET.MGR120 that is a main file. AUD_SET.MGR120 has user interface entry information and TL and TG management information.

A TrackLinks stream file manages all track link information in a playable state. TG_{—}0000 is a TG which manages all tracks described in the TrackLinks stream file. For TG_{—}0000, maintenance is executed by a device (for example, a contents data recorder) which uses the removable recording medium.

A PRTLs stream file manages all track link information not in the playable state. TG_{—}9999 is a TG which manages all tracks described in PRTLs and exists only in the case of a preset model. TG_xxxx is a TG which can be freely defined by a user or a device. In “xxxx,” a 4 digit (0000 to 9999) number (ASCII code) is described. Note that contents of the preset model will be described later.

(3.1) AUD_SET.MGR File

AUD_SET.MGR120 that is the main file includes module rows as shown in Table 1, in other words, (i) user interface entry information, (ii) track link management information and (iii) track group management information.

(3.1.1) User Interface Entry Information

TABLE 1

USER INTERFACE ENTRY INFORMATION
TRACK LINK MANAGEMENT INFORMATION
TRACK GROUP MANAGEMENT INFORMATION

The user interface entry information has an entry structure as shown in Table 2.

TABLE 2

| RELATIVE BYTE | BYTE | | |
|---|---|---|---|
| POSITION | LENGTH | FIELD NAME | FORMAT |
| 0 | 10 | Audio Format Identifier | uimsbf |
| 10 | 1 | Book Version | VER |
| 11 | 1 | Flag | FL |
| 12 | 3 | Last Accessed UIE TG_ID | uimsbf |
| 15 | 1 | Resume support flag | bslbf |
| 16 | 14 | Last Accessed UIE TG_ID | TIME |
| | | recorded Date | |
| 30 | 4 | Number of UIE TGs | uimsbf |
| 34 | 4 | UIE TG_ID(1) for Base | uimsbf |
| | | Track Set | |
| 38 | 20 | UIE TG_ID(1) Name | Character |
| 58 | 4 | UIE TG_ID(2) | uimsbf |
| 62 | 20 | UIE TG_ID(2) Name | Character |
| | | . . . | |
| | 4 | UIE TG_ID(n) | uimsbf |
| | 20 | UIE TG_ID(n) Name | Character |

(uimsbf = unsigned integer most significant bit first)

In “Audio Format Identifier,”“AUDIO” is described by the ASCII code. In “BookVersion,” aversion of a book is described. In the case of version 1.0, “0x10” is described.

“Flag” has a structure as shown in Table 3.

TABLE 3

| | | | | | | | |
|---|---|---|---|---|---|---|---|
| bit7 | bit6 | bit5 | bit4 | bit3 | bit2 | bit1 | bit0 |

| | |
|---|---|
| Reserved | Preset |

“Reserved” (bit7 to 1) are bits reserved for the future, which are set to 0b. In the preset model or the like, “Preset” (bit0) is set to 1b when music contents for which a license is not purchased exist, and is set to 0b when the music contents do not exist.

In “Last Accessed UIE TG_ID” (see Table 2), an ID of the last accessed TG is described. Last Accessed UIE TG_ID is used as a resume point.

“Resume Support Flag” has a structure as shown in Table 4.

TABLE 4

| | | | | | | | |
|---|---|---|---|---|---|---|---|
| bit7 | bit6 | bit5 | bit4 | bit3 | bit2 | bit1 | bit0 |

| | |
|---|---|
| Reserved | Resume |

“Reserved” (bit7 to 1) are bits reserved for the future, which are set to 0b. “Resume” (bit0) is described as 1b in a device which supports a resume function, and is described as 0b in a device which does not support the resume function.

In “Last Accessed UIE TG_ID recorded Date” (see Table 2), time when the ID of the last accessed TG is recorded is described. A “TIME” format is expressed in the following manner by an ASCII code for 14 bytes. Specifically, the “TIME” format is expressed by using 4 digits for the year, 2 digits for the month, 2 digits for the day, 2 digits for the time (24-hour display), 2 digits for the minute and 2 digits for the second. In the case of a device having no timer, all the above are set to 0.

In “Number of UIE TGs,” a total number of IDs of the most significant TG to be a user interface entry positioned under AUD_SET.MGR120.

In “UIE TG_ID (1) for Base Track Set,” a first UIE TG_ID is described. Specifically, 0000 is described by the ASCII code. The UIE TG_ID corresponds to the stream file TG_{—}0000. The UIE TG_ID corresponds to xxxx in the stream file TG_xxxx. TG_{—}0000 necessarily exists as the TG which manages all tracks.

In “UIE TG_ID (1) Name,” a name of UIE TG_ID (1) is described by the ASCII code. Specifically, TG Specific Structure Name of a corresponding TG structure is copied. To be more specific, in “UIE TG_ID (1) Name,” TrackSetBase is described.

In “UIE TG_ID (2),” a second UIE TG_ID is described. To be more specific, a 4 digit number is described by the ASCII code. The 4 digit number corresponds to the stream file TG_xxxx.

In “UIE TG_ID (2) Name,”a name of UIE TG_ID (2) is described by the ASCII code, as in the case of “UIE TG_ID (1) Name.”

In “UIE TG_ID (n),” an n-th UIE TG_ID is described. To be more specific, a 4 digit number is described by the ASCII code. The 4 digit number corresponds to the stream file TG_xxxx. Moreover, in “UIE TG_ID (n) Name,” a name of UIE TG_ID (n) is described by the ASCII code, as in the case of “UIE TG_ID (1) Name.”

(3.1.2) Track Link Management Information

The track link management information has an entry structure as shown in Table 5.

TABLE 5

| RELATIVE BYTE | | | |
|---|---|---|---|
| POSITION | BYTE LENGTH | FIELD NAME | FORMAT |
| 0 | 20 | Track Link Location | Character |
| 20 | 20 | Prercorded Track | Character |
| | | Link Location | |

In “Tack Link Location,” file names (TrackLinks) under which TLs are recorded are described by the ASCII code.

In “Prerecorded Track Link Location,” file names under which TLs are recorded after purchase of the removable recording medium are described by the ASCII code. “Prerecorded TrackLink Location” is used in the preset model. In the case of the preset model, PRTLs are described in “Prerecorded Track Link Location.” Other than the preset model, “Prerecorded Track Link Location” is ignored.

(3.1.3) Track Group Management Information

The track group management information has an entry structure as shown in Table 6.

TABLE 6

| RELATIVE BYTE | BYTE | | |
|---|---|---|---|
| POSITION | LENGTH | FIELD NAME | FORMAT |
| 0 | 4 | Number of Track Groups | uimsbf |
| 4 | 4 | Maximum Track Group ID | uimsbf |

In “Number of Track Groups,” a total number of TGs is described. In “MaximumTrack Group ID,” a maximum value of TG_ID is described. To be more specific, a 4 digit number is described by ASCII code. However, since “9999” is assigned for the preset model, the number is not considered as the maximum value.

(3.2) TrackLinks Stream File/PRTLs Stream File

The TrackLinks stream file and the PRTLs stream file have a structure as shown in Table 7.

TABLE 7

| RELATIVE BYTE | BYTE | | |
|---|---|---|---|
| POSITION | LENGTH | FIELD NAME | FORMAT |
| 0 | 4 | Number of Track Links | uimsbf |
| 4 | 4 | Number of Valid Track | uimsbf |
| | | Links | |
| 8 | 324 | Track Link Information (1) | TL |
| 332 | 324 | Track Link Information (2) | TL |
| | | . . . | |
| | 324 | Track Link Information (n) | TL |

In “Number of Track Links,” a total number of TLs included in the TrackLinks stream file or the PRTLs stream file is described. In “Number of Valid Track Links,” the number of valid TLs among the TLs included in the TrackLinks stream file and the PRTLs stream file.

“Track Link Information (1) to (n)” has a structure in which n of TL structures are arranged. n is a value of “Number of Track Links” field. IDs of TLs are allocated in ascending order from “1” as shown in Table 7.

Note that, in this embodiment, IDs of TLs in the TrackLinks stream file are expressed as TL_ID, and IDs of TLs in the PRTLs stream file are expressed as PRTL_ID.

(3.2.1) TL Structure

The TL structure has a structure as shown in Table 8.

TABLE 8

| RELATIVE | | | |
|---|---|---|---|
| BYTE | BYTE | | |
| POSITION | LENGTH | FIELD NAME | FORMAT |
| 0 | 1 | TL Specific Structure TYPE | uimsbf |
| 1 | 2 | Length of Structure | uimsbf |
| 3 | 1 | TL Flag | TLF |
| 4 | 1 | Link Count | uimsbf |
| 5 | 7 | Music Contents ID | uimsbf |
| 12 | 4 | Start Point in Contents File | uimsbf |
| 16 | 4 | Content Length | uimsbf |
| 20 | 14 | Last Accessed Time | Character |
| 34 | 4 | Resume Point | uimsbf |
| 38 | 2 | Playback Counter | uimsbf |
| 40 | 1 | My Rating Info (MD for User) | uimsbf |
| 41 | 1 | Character Set of MetaData | bslbf |
| 42 | 80 | Title (MD) | Character |
| 122 | 40 | Title KANA (MD) | Character |
| 162 | 20 | Artist Name (MD) | Character |
| 182 | 20 | Artist KANA (MD) | Character |
| 202 | 20 | Genre (MD) | Character |
| 222 | 20 | Genre KANA (MD) | Character |
| 242 | 20 | Composer (MD) | Character |
| 262 | 60 | Album Title (MD) | Character |
| 322 | 2 | Track No in CD (MD) | uimsbf |

In “TL TYPE,” a type of TL specific structure (see Table 9 is described. Note that, in this embodiment, Japanese system (TYPE 1) is defined.

TABLE 9

| VALUE | INTERPRETATION |
|---|---|
| 0x00 | UNDEFINED |
| 0x01 | TYPE1 (JAPAN Specific) |
| 0x02-0xFF | Reserved |

In “Length of Structure” (see Table 8), a length (the number of bytes) of the TL structure is described.

“TL Flag” has a structure as shown in Table 10.

TABLE 10

| | | | | | | | |
|---|---|---|---|---|---|---|---|
| bit7 | bit6 | bit5 | bit4 | bit3 | bit2 | bit1 | bit0 |

| | | | | |
|---|---|---|---|---|
| V | Reserved | PS | PE | Part |

In “V (bit7),” information indicating whether or not the TL structure is valid is described. To be more specific, if the TL structure is valid, “V (bit7)” is set to 1b. If the TL structure is invalid, “V (bit7)” is set to 0b. “V (bit7)” is utilized for simple deletion of the TL structure.

“Reserved (bit6 to 3)” are bits reserved for the future, which are set to 0b. In “PS (bit2),” 1b is set in the case of a link to a song related to the preset model, and 0b is set in other cases.

In “PE (bit1),” 1b is set in the case of a link to a playable song, that is, if there is a license for the song or if the song is not encrypted. On the other hand, 0b is set if it is impossible to play the song, that is, if the song is encrypted and there is no license for the song.

In “Part (bit0),” 1b is set if a plurality of songs are recorded as MC and if a part of the songs is designated. If the MC is 1 song, 0b is set. As long as “Part (bit0)” is set to 1b, “Start Point in Contents File” and “Content Length” fields become valid.

In “Link Count” (see Table 8), a total number of links from TGs is described. In “Music Contents ID,” Music Contents IDs are described. To be more specific, a number corresponding to xxxxxxx of the AUDxxxxxxx.AIF file of the contents file is described by the ASCII code.

In “Start Point in Contents File,” a link start position of a music contents file is designated by a byte position from a top of the file. In “Content Length,” a link range (byte length) to the music contents file is described. As described above, only if Part bit (see Table 10) of TL_Flag is 1b, “Start Point in Contents File” and “Content Length” fields become valid.

In “Last Accessed Time,” time of access to the last played music contents file is recorded. In “Resume Point,” a playback start position of the music contents file (AUDxxxxxxx.AIF file) is designated by a byte position from a top of the file.

In “Playback Counter,” the number of times of instructing playback start is described. Note that the number of times described in “Playback Counter” field does not include playback by resume. In “My Rating Info,” information weighted on a scale of 1 to 10 is described, which is input by the user.

In “Character Set of Metadata,” character codes (see Table 11) in a metadata field are defined.

TABLE 11

| VALUE | INTERPRETATION |
|---|---|
| 0x00 | Reserved |
| 0x01 | ASCII & SHIFT J I S |
| 0x02 | Unicode |
| 0x03-0xFF | Reserved |

In “Title (MetaData, hereinafter abbreviated as MD)” (see Table 8), a track title is described. As the character code, one designated in “Character Set of Metadata” field is used. Termination of the track title is performed by storing a NULL character.

In “Title Kana (MD),” kana for searching the track title is described by double-byte katakana. As the character code, the code designated in “Character Set of Metadata” field is used. Termination of the track title is performed by storing a NULL character.

In “Artist Name (MD),” an artist name is described. As the character code, the code designated in “Character Set of Metadata” field is used. Termination of the track title is performed by storing a NULL character.

In “Artist Name Kana (MD),” kana for searching the artist name is described by double-byte katakana. As the character code, the code designated in “Character Set of Metadata” field is used. Termination of the track title is performed by storing a NULL character.

In “Genre (MD),” a genre is described. As the character code, the code designated in “Character Set of Metadata” field is used. Termination of the track title is performed by storing a NULL character.

In “Genre Kana (MD),” kana for searching the genre is described by double-byte katakana. As the character code, the code designated in “Character Set of Metadata” field is used. Termination of the track title is performed by storing a NULL character.

In “Composer (MD),” a name of a composer is described by double-byte katakana. As the character code, the code designated in “Character Set of Metadata” field is used. Termination of the track title is performed by storing a NULL character.

In “Album Title (MD),” a title of a music album (CD) is described by double-byte katakana. As the character code, the code designated in “Character Set of Metadata” field is used. Termination of the track title is performed by storing a NULL character.

In “Track Number in CD (MD),” a track number in the case of the music album is described.

(3.3) TG_xxxx Stream File

A TG_xxxx stream file has a structure as shown in Table 12.

TABLE 12

| BYTE | BYTE | | |
|---|---|---|---|
| POSITION | LENGTH | FIELD NAME | FORMAT |
| 0 | 1 | TG Specific Structure TYPE | bslbf |
| 1 | 2 | TG Flag | TGF |
| 2 | 20 | TG Specific Structure Name | Character |
| 22 | 1 | Link Count | uimsbf |
| 23 | 1 | Resume element | uimsbf |
| 24 | 64 | TG Specific Structure TYPE | bslbf |
| | | Specific Area | |
| 86 | 2 | Number of elements | uimsbf |
| 88 | 4 | element ID(1) | uimsbf |
| 92 | 20 | element ID(1) Name | Character |
| | | . . . | |
| | 4 | element ID(n) | uimsbf |
| | 20 | element ID(n) Name | Character |

In “TG Specific Structure TYPE,” TG specific structure TYPE (see Table 13) is described.

TABLE 13

| VALUE | INTERPRETATION |
|---|---|
| 0x00 | TYPE 0 (TRACK SET BASE) |
| 0x01 | TYPE 1 (ALBUM DESCRIPTION) |
| 0x02 | TYPE 2 (PLAYLIST) |
| 0x03 | TYPE 3 (GROUP) |
| 0x04-0xFF | Reserved |
| 0xFF | TYPE FF (PRESET) |

“TG Flag” has a structure as shown in Table 14.

TABLE 14

| | | | | | | | |
|---|---|---|---|---|---|---|---|
| bit7 | bit6 | bit5 | bit4 | bit3 | bit2 | bit1 | bit0 |

| | | |
|---|---|---|
| Reserved | TL/TG | S/G |

“Reserved (bit7 to 2)” are bits reserved for the future, which are set to 0b. Note that the bits are to be used for character code identifying information.

In “TL/TG (bit1),” 1b is set in the case of a TL list, and 0b is set in the case of a TG list. In “S/G (bit0),” 1b is set if the order of the list is the order of playback, and 0b is set if the order thereof is not the order of playback.

In “TG Specific Structure Name” (see Table 12), a name of a TG Specific structure is described by the ASCII code. In “Link Count,” a total number of links from TGs is described. Note that a link referred to from the user interface entry information is also counted as 1 in the number of links.

In “Resume element,” a number of a resume element is described. The number corresponds to x in element ID (x). “Resume element” becomes valid only when S/G bit of TG_Flag is 1.

“TG Specific Structure TYPE Specific Area” is an area for defining a structure dependent on the TG Specific structure. In “Number of elements,” a total number of elements which belong to the TG is described. In “element ID (1) to (n),” respective element IDs are described.

In “element ID (1) Name to element ID (n) Name,” names of the element IDs are described.

(3.3.1) TG_{—}0000 Stream File

A TG_{—}0000 stream file is a TG which manages TLs managed by the TrackLinks stream file. The TG_{—}0000 stream file is defined by the above-described TG_xxxx structure (TG_xxxx stream file) and has the following restrictions.
TG Specific Structure TYPE=0x00
TG Flag=0x2
TG Specific Structure Name=Track_Base
Link Count=0
Number of elements: Coincide with the number of valid TLs managed by TrackLinks stream file
element ID (1) to (n): TL_ID is described
   (3.3.2) TG_{—}9999 Stream File

A TG_{—}9999 stream file is a TG which exists in an initial state only in the case of the preset model and manages TLs managed by the PRTLs stream file. The TG_{—}9999 stream file is defined by the above-described TG_xxxx structure (TG_xxxx stream file) and has the following restrictions.
TG Specific Structure TYPE=0xFF
TG Flag=0x2
TG Specific Structure Name=Preset_Track_Base
Link Count=0
Number of elements: Coincide with the number of valid TLs managed by PRTLs stream file
element ID (1) to (n): PRTL_ID is described
   (3.3.3) TG_xxxx Stream File

The TG_xxxx stream file is expressed by a TL list or a TG list. If the TG_xxxx stream file is expressed by the TL list, TL_ID managed by the TrackLinks stream file has to be described in element_ID. Note that PRTL_ID of the PRTLs stream file cannot be referred to.

(4) Structure of AUDxxxxxxx.AIF File

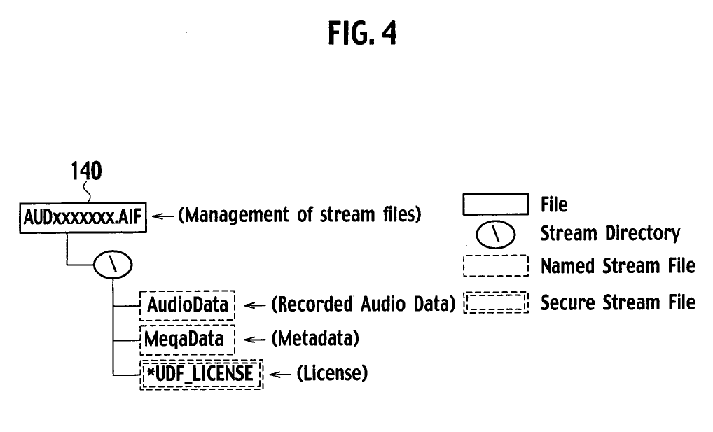

FIG. 4 shows a structure of the AUDxxxxxxx.AIF file. As shown in FIG. 4, the AUDxxxxxxx.AIF file 140 includes an AudioData stream file (AudioData), a MetaData stream file (MetaData) and a *UDF_LICENCE secure stream file (*UDF_LICENCE).

(4.1) AUDxxxxxxx.AIF File

The AUDxxxxxxx.AIF file 140 that is a main file includes module rows as shown in Table 15, in other words, (i) audio data management information, (ii) metadata management information and (iii) license management information.

TABLE 15

AUDIO DATA MANAGEMENT INFORMATION
METADATA MANAGEMENT INFORMATION
LICENSE MANAGEMENT INFORMATION

(4.1.1) Audio Data Management Information

The audio data management information has an entry structure as shown in Table 16.

TABLE 16

| RELATIVE BYTE | BYTE | | |
|---|---|---|---|
| POSITION | LENGTH | FIELD NAME | FORMAT |
| 0 | 4 | Number of Tracks | uimsbf |
| 4 | 1 | AUD Flag | bslbf |
| 5 | 4 | Playback Time | Character |
| 9 | 4 | File Size | uimsbf |
| 13 | 1 | Audio Format (Codec) | bslbf |
| 14 | 2 | Bit rate | uimsbf |
| 16 | 16 | File Create Date | TIME |
| 32 | 20 | Audio File Location | Character |

In “Number of Tracks,” the number of tracks recorded in the AudioData stream file is described.

“AUD Flag” has a structure as shown in Table 17.

TABLE 17

| | | | | | | | |
|---|---|---|---|---|---|---|---|
| bit7 | bit6 | bit5 | bit4 | bit3 | bit2 | bit1 | bit0 |

| | |
|---|---|
| Reserved | Enc |

“Reserved (bit7 to 1)” are bits reserved for the future, which are set to 0b. In “Enc (bit0),” 1b is set if a Track Data portion of the AudioData stream file is encrypted, and 0b is set if the portion is not encrypted.

In “Playback Time” (see Table 16), playback time for all tracks is described. In “File Size,” a file size of the AudioData stream file is described. In “Audio Format (Codec),” an Audio Format (see Table 18) is described.

TABLE 18

| VALUE | INTERPRETATION |
|---|---|
| 0x00 | Reserved |
| 0x01 | MPEG4-AAC |
| 0x02 | MP3 |
| 0x03 | Linear PCM |
| 0x04-0XFF | Reserved |

In “Bit Rate” (see Table 16), a bit rate (unit: kbps) is described. In “File Create Date,” a date when a file is created is described. In “Audio File Location,” a name of a file in which audio data is recorded is described (as AudioData) by the ASCII code.

(4.1.2) Metadata Management Information

The metadata management information has a structure as shown in Table 19.

TABLE 19

| RELATIVE | | | |
|---|---|---|---|
| BYTE | BYTE | | |
| POSITION | LENGTH | FIELD NAME | FORMAT |
| 0 | 1 | Character Set in | bslbf |
| | | MetaData File | |
| 1 | 1 | MetaData Format | bslbf |
| 2 | 20 | MetaData File Location | Character |

In “Character Set in Metadata File,” a character code (see Table 20) of the MetaData stream file is defined.

TABLE 20

| VALUE | INTERPRETATION |
|---|---|
| 0x00 | Reserved |
| 0x01 | ASCII & SHIFT JIS |
| 0x02 | Unicode |
| 0x03-0xFF | Reserved |

In “MetaData Format,” a TG Specific structure TYPE (see Table 21) is described.

TABLE 21

| VALUE | INTERPRETATION |
|---|---|
| 0x00 | Reserved |
| 0x01 | TYPE 1 (VARIABLE LENGTH DESCRIPTION) |
| 0x02-0xFF | Reserved |

In “MetaData File Location” (see Table 19), a name of a file in which metadata is recorded is described (as MetaData) by the ASCII code.

(4.1.3) License Management Information

The license management information has a structure as shown in Table 22.

TABLE 22

| RELATIVE | | | |
|---|---|---|---|
| BYTE | BYTE | | |
| POSITION | LENGTH | FIELD NAME | FORMAT |
| 0 | 2 | License Flag | uimsbf |
| 1 | 1 | Reserved | |
| 2 | 20 | License File | Character |
| | | Location | |

“License Flag” has a structure as shown in Table 23.

TABLE 23

| | | | | | | | |
|---|---|---|---|---|---|---|---|
| bit7 | bit6 | bit5 | bit4 | bit3 | bit2 | bit1 | bit0 |

| | | |
|---|---|---|
| Reserved | PS | LE |

“Reserved (bit7 to 2)” are bits reserved for the future, which are set to 0b.

In “PS (bit1),” 1b is set in the case of the preset model, and 0b is set in other cases. In “LE (bit0),” 1b is set if a license exists, and 0b is set if the license does not exist.

In “License File Location” (see Table 22), a name of a file in which a license (a content key and utilization conditions) is recorded is described by the ASCII code. To be more specific, *UDF_LICENSE is described only if LE bit of License Flag is 1b.

(4.2) AudioData Stream File

The AudioData stream file includes module rows as shown in Table 24, in other words, (i) Audio Data Header and (ii) Track Data.

TABLE 24

Audio Data Header
Track Data#1
. . .
Track Data#N

(4.2.1) Audio Data Header

Audio Data Header has an entry structure as shown in Table 25. Note that Audio Data Header is not to be encrypted.

TABLE 25

| RELATIVE | | | |
|---|---|---|---|
| BYTE | BYTE | | |
| POSITION | LENGTH | FIELD NAME | FORMAT |
| 0 | 4 | Length of Audio Data Header | uimsbf |
| 4 | 2 | Number of Tracks (=n) | uimsbf |
| 6 | 4 | Length of Track Data (#1) | uimsbf |
| | | . . . | |
| | 4 | Length of Track Data (#n) | uimsbf |
| | | Reserved | bslbf |

In “Length of Audio Data Header,” a length (the number of bytes) of Audio Data Header is described. In “Number of Tracks,” the number of tracks recorded in the AudioData stream file is described. In “Length of Track Data (#1) to (#n),” a length (the number of bytes) of Track Data is described.

(4.2.2) Track Data

In Track Data, data according to Audio Format is recorded. Note that Track Data may be encrypted.

(4.3) MetaData Stream File

The MetaData stream file has a structure as shown in Table 26.

TABLE 26

| RELATIVE | | | |
|---|---|---|---|
| BYTE | BYTE | | |
| POSITION | LENGTH | FIELD NAME | FORMAT |
| 0 | 1 | MD Specific Structure TYPE | uimsbf |
| 1 | 1 | Length of Title field (=a) | uimsbf |
| 2 | a | Title | Character |
| 2+a | 1 | Length of Title KANA field (=b) | uimsbf |
| 3+a | b | Title KANA | Character |
| | 1 | Length of Artist field (=c) | uimsbf |
| | c | Artist | Character |
| | 1 | Length of Artist KANA field (=d) | uimsbf |
| | d | Artist KANA | Character |
| | 1 | Length of Genre field (=e) | uimsbf |
| | e | Genre | Character |
| | 1 | Length of Genre KANA field (=f) | uimsbf |
| | f | Genre KANA | Character |
| | 1 | Length of Label field (=g) | uimsbf |
| | g | Label | Character |
| | 1 | Length of Credit field (=h) | uimsbf |
| | h | Credit | Character |
| | 1 | Length of Release Date field (=i) | uimsbf |
| | i | Release Date | Character |
| | 1 | Length of Album field (=j) | uimsbf |
| | j | Album field | Character |
| | 1 | Length of Composer field (=k) | uimsbf |
| | k | Composer field | Character |
| | 1 | CD Track Number | uimsbf |
| | 20 | Pointer to CD jacket | |
| | 1 | Length of Contents Source field | uimsbf |
| | | (=m) | |
| | m | Contents Source | Character |
| | 1 | Length of Language field (=n) | uimsbf |
| | n | Language | Character |
| | 1 | Length of URL field (=p) | uimsbf |
| | p | URL | Character |
| | 1 | Length of Detail Info field (=q) | uimsbf |
| | q | Detail Info | Character |

(4.4) *UDF_Secure Stream File

In the *UDF_LICENCE secure stream file, a license (a content key and utilization conditions) is described. If the *UDF_LICENCE secure stream file exists, an application can decrypt the encrypted AudioData stream file.

### (MUSIC CONTENTS MANAGEMENT MODEL CONFIGURATION EXAMPLE)

Next, description will be given of a management model configuration example of music contents using the contents data structure according to this embodiment described above.

### (1) Configuration Example 1

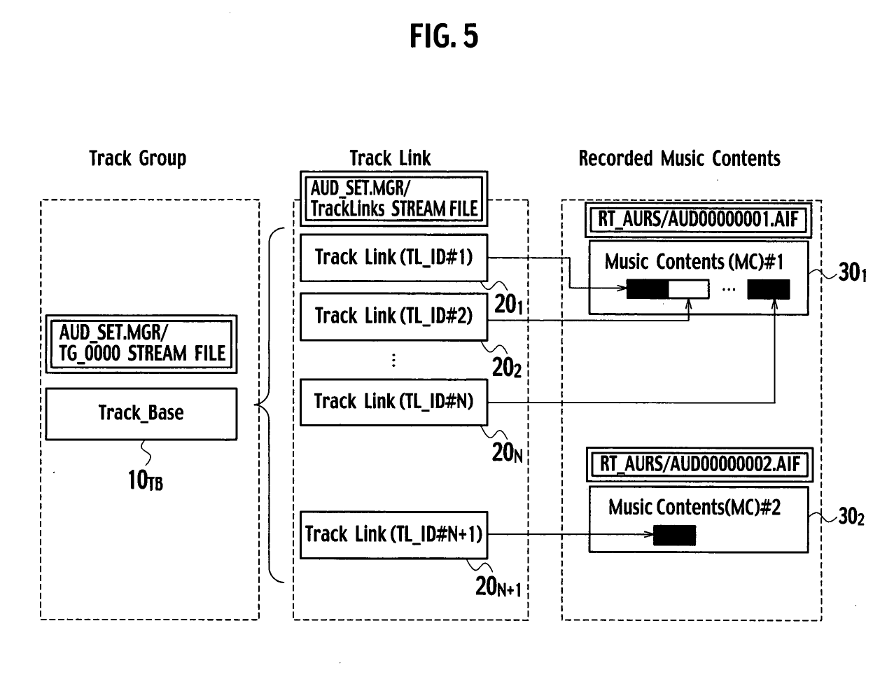

FIG. 5 shows a model configuration example using “Track_Base (TG10_{TB}).”

Track_Base (TG10_{TB}) is a TG which manages all lists of tracks recorded in a state where the user can listen to the tracks. Note that, if the music contents (MC30₁ and 30₂) are encrypted, a license for decrypting is required.

Track_Base (TG10_{TB}) exists as a TG_{—}0000 stream file under the AUD_SET.MGR file. Track_Base (TG10_{TB}) manages all TLs (TL20₁ to 20_{N+1}) which are managed as the TrackLinks stream file under the AUD_SET.MGR file.

### (2) Configuration Example 2

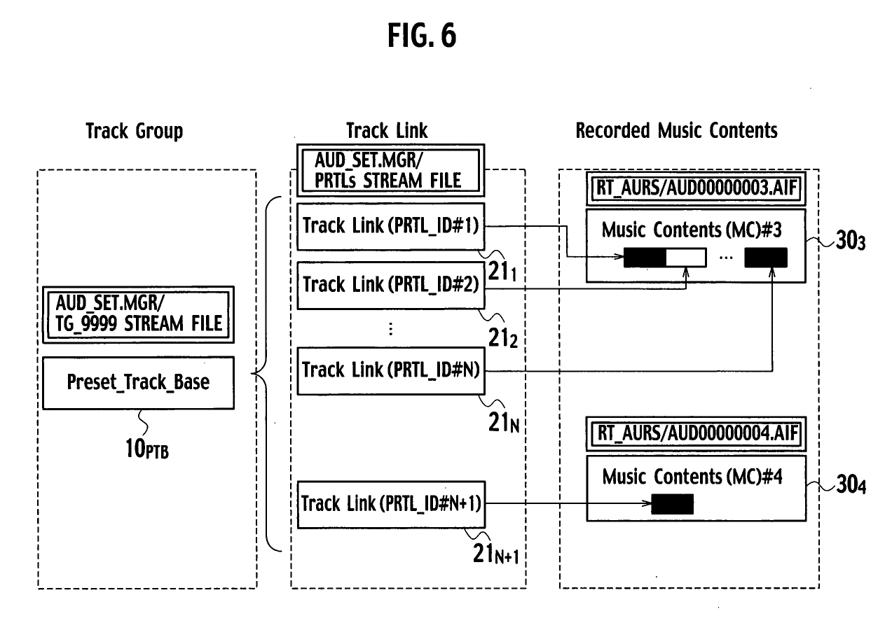

FIG. 6 shows a model configuration example using “Preset_Track_Base (TG10_{PTB}).” Preset_Track_Base (TG10_{PTB}) is a file (TG) which exists only in the case of the “preset model.”

The preset model is a business model that the encrypted music contents (MC30₃ and 30₄) are sold to a user in a state where the contents are recorded in a removable recording medium and the user purchases tracks that he/she likes from a displayed list.

In the preset model, the user may acquire only a license for decrypting the encrypted music contents (MC30₃ and 30₄) when he/she purchases the tracks that he/she likes. Thus, the user does not have to download the tracks (music contents) that he/she likes from a server or the like, and can promptly purchase the music contents.

Moreover, in the preset mode 1, the encrypted music contents (MC30₃ and 30₄) are recorded in the AUDxxxxxxx.AIF file 140 (see FIG. 2) which is positioned under the RT_AURS directory 130, as in the case of the music contents that can be listened to by the user. However, since at first the user has no license (*UDF_LICENCE secure stream file), the encrypted music contents (MC30₃ and 30₄) cannot be played as they are.

TL21₁ to 21_{N+1} are managed as the PRTLs stream file under the AUD_SET.MGR file and are managed separately from the TrackLinks stream file which manages the music contents that can be listened to by the user.

Furthermore, in the preset model, a TG managing all lists of tracks which are recorded in a state where the tracks cannot be listened to by the user, in other words, for which the user has no license for decryption exists as the TG_{—}9999 stream file under the AUD_SET.MGR file.

The TG_{—}9999 stream file manages all TLs managed as the PRTLs stream file positioned under the AUD_SET.MGR file. The TLs managed as the PRTLs stream file have a restriction that the TLs cannot be linked from the TG defined by the user.

In the case where the user acquires (purchases) a license for the encrypted music contents, TLs corresponding to the MC are deleted from the PRTLs stream file and are added to the TrackLinks stream file.

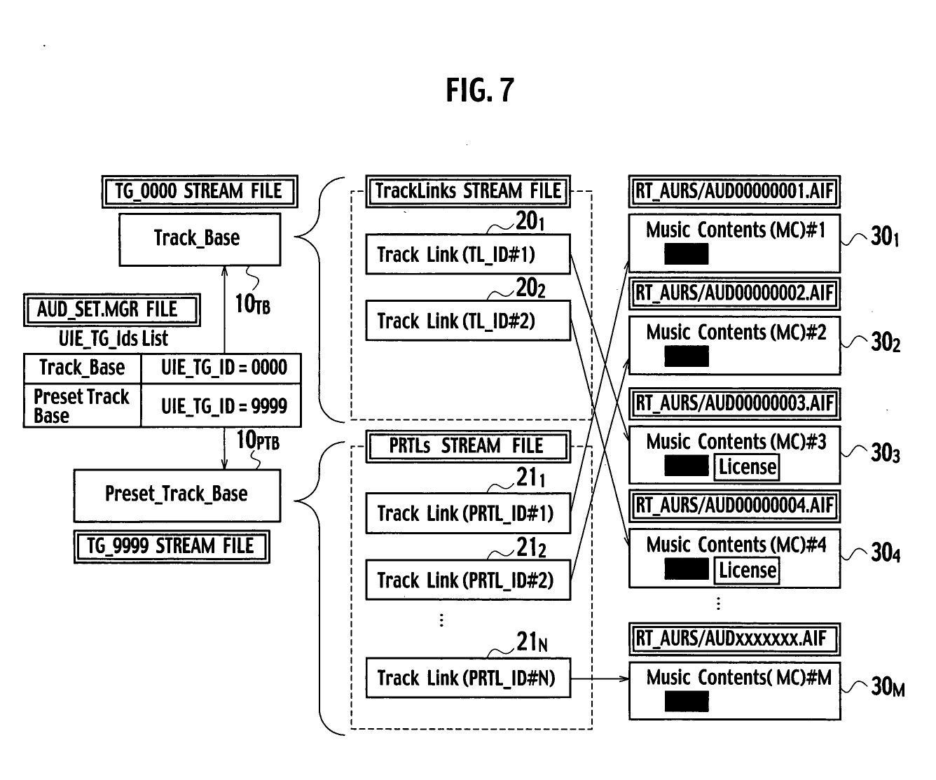

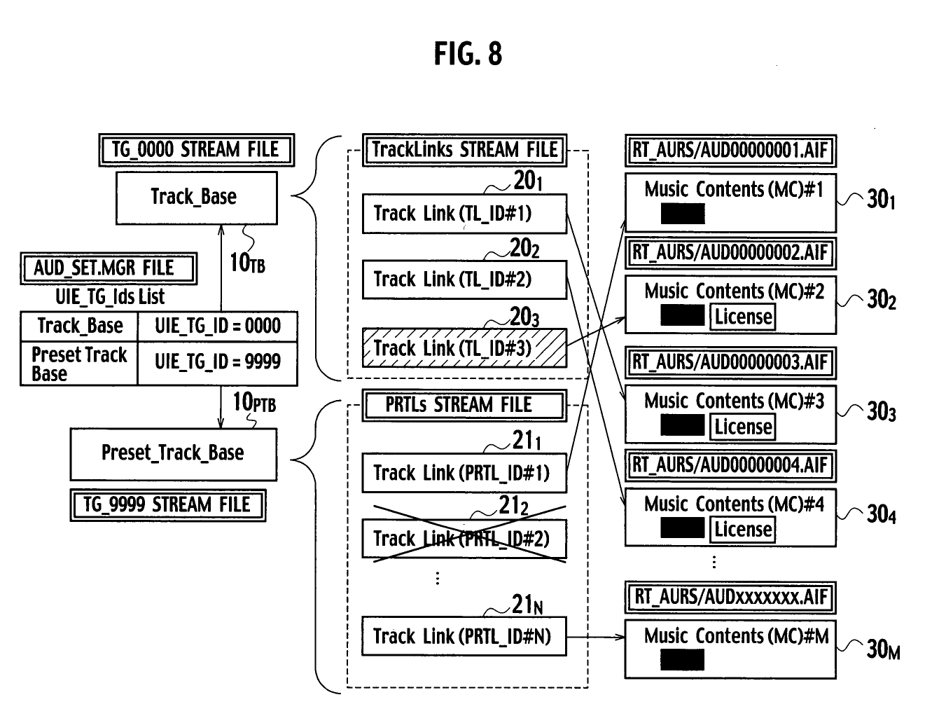

FIGS. 7 and 8 show the state where, when the user acquires (purchases) a license for the encrypted music contents, TLs corresponding to the MC are deleted from the PRTLs stream file and are added to the TrackLinks stream file.

FIG. 7 shows a state of management of the music contents before acquisition of a license (a content key and utilization conditions). As shown in FIG. 7, licenses are already acquired for MC30₃ and 30₄ (which are denoted with “Licence” in FIG. 7). On the other hand, licenses are not yet acquired for MC30₁, 30₂ and 30_{M}.

Here, it is assumed that the user newly acquires a license for MC30₂. FIG. 8 shows a state of management of the music contents after acquisition of the license for MC30₂. As shown in FIG. 8, TL21₂ corresponding to MC30₂ is deleted from the PRTLs stream file.

Meanwhile, TL20₃ (TL_ID#3) is added, as a TL corresponding to MC30₂, to the TrackLinks stream file.

### (3) Configuration Example 3

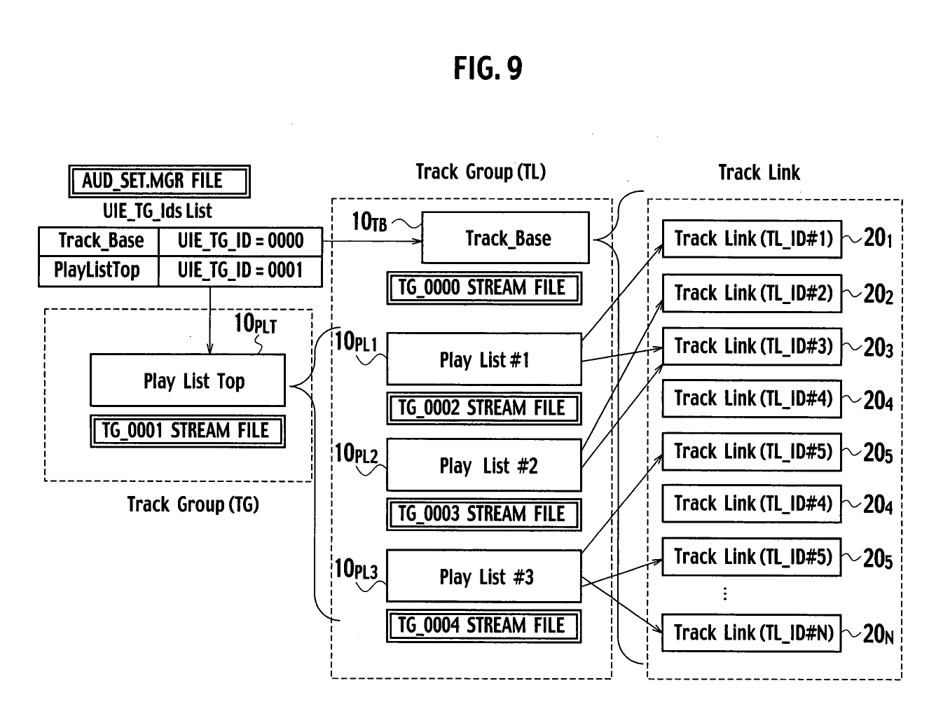

FIG. 9 shows a basic configuration example of a music contents (audio data) management model. As shown in FIG. 9, in the user interface entry information (see Table 2) which is included in the AUD_SET.MGR file, a list of UIE TG_IDs which should be first accessed exists.

In the configuration example shown in FIG. 9, two lists exist. One is Track_Base (TG10_{TB}) which has TG_ID of 0000 and manages all TLs that can be listened to by the user. Track_Base (TG10_{TB}) necessarily exists, and a contents data recorder is required to do maintenance of the contents of Track_Base (TG10_{TB}).

The other one is Play List Top (10_{PLT}) which has TG_ID of 0001 and is to be an entry of a playlist. Play List Top (10_{PLT}) is expressed as a list of TGs. In the configuration example shown in FIG. 9, three playlists are managed.

Play List #1, #2 and #3 (TG10_{PL1}, 10_{PL2} and 10_{PL3}) correspond to TG_ID 0002, 0003 and 0004, respectively. The user can newly create or delete Play List #1, #2 and #3 (TG10_{PL1}, 10_{PL2} and 10_{PL3}) Moreover, the user can edit contents of Play List #1, #2 and #3 (TG10_{PL1}, 10_{PL2} and 10_{PL3}). Each of the playlists is expressed by a list of TLs (TL20₁ to 20_{N}).

### (4) Configuration Example 4

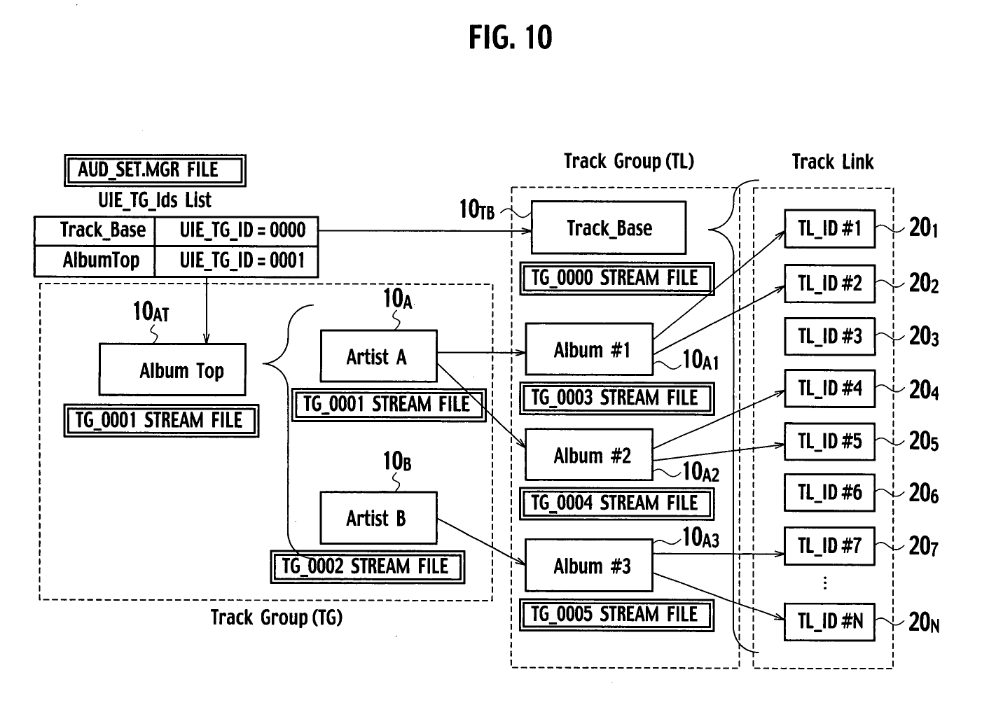

FIG. 10 shows a configuration example in the case where music albums are managed. A difference between this configuration example and the playlists (Play List #1, #2 and #3 (TG10_{PL1}, 10_{PL2} and 10_{PL3})) shown in FIG. 9 is that, in ripping a CD, a contents data recorder generates related folders and files (Album Top (TG10_{AT}), Artist A (TG10_{A}), Artist B (TG10_{B}), Album #1, #2 and #3 (TG10_{A1}, TG10_{A2} and TG10_{A3})), and the folders and files cannot be edited by the user.

Moreover, in this configuration example, Track_Base (TG10_{TB}) does not manage information on the music albums.

### Example

Next, with reference to the drawings, description will be given of an example using the contents data structure described above.

### CONFIGURATION OF CONTENTS DATA RECORDER

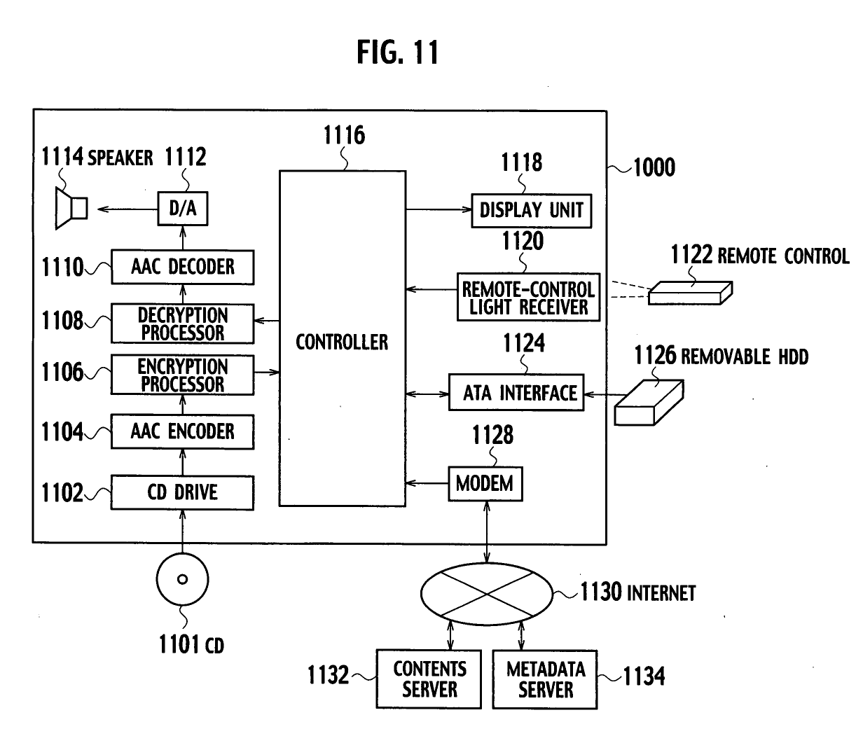

FIG. 11 shows a configuration of a music recorder 1000 (a contents data recorder) according to this example.

As shown in FIG. 11, the music recorder 1000 has a CD drive 1102 which drives a CD 1101.

An AAC encoder 1104 compresses a data volume of music contents (audio data) which are read by the CD drive 1102. To be more specific, the AAC encoder 1104 compresses the audio data based on MPEG-4 AAC (ISO/IEC14496-3).

An encryption processor 1106 encrypts the audio data compressed by the AAC encoder 1104. Moreover, a decryption processor 1108 decrypts the encrypted audio data.

An AAC decoder 1110 decodes (decompresses) the audio data which is output by the decoding processor 1108 and compressed based on MPEG-4 AAC.

A D/A converter 1112 converts the audio data output by the AAC decoder 1110 into an analog signal. The analog signal output by the D/A converter 1112 drives a speaker 1114.

A controller 1116 includes a MPU and the like and controls respective parts connected thereto. Moreover, the controller 1116 includes a timer so that date and time information can be acquired.

The controller 1116 generates track link information (link information) which indicates positions, sizes and the like of MCs on a removable HDD 1126. In this embodiment, the controller 1116 constitutes a link information generation unit.

Moreover, the controller 1116 describes contents of the MC (for example, titles and artist names) and acquires metadata used for retrieval of the MC (individual file). In this embodiment, the controller 1116 constitutes a metadata acquisition unit together with a modem 1128.

Furthermore, the controller 1116 generates an AUD_SET.MGR file (management file) including the track link information and the metadata. In this embodiment, the controller 1116 constitutes a management file generation unit.

Moreover, the controller 1116 retrieves the MC by using the AUD_SET.MGR file, and thus constitutes a contents retrieval unit in this embodiment. Note that, as described above, the AUD_SET.MGR file includes license management information (*UDF_LICENCE secure stream file) which allows a playback of the MC. The controller 1116 plays the MC based on the license management information, and thus constitutes a contents playback unit together with the decoding processor 1108 in this embodiment.

A display unit 1118 displays information output by the controller 1116, for example, the number of tracks in music contents, track numbers and metadata such as titles and artist names. A remote-control light receiver 1120 receives infrared light transmitted from a remote control 1122.

An ATA interface 1124 is an interface (At Attachment) for connecting the controller 1116 to the removable HDD 1126 so as to communicate with each other.

The removable HDD 1126 is a removable recording medium which can be removed from the music recorder 1000. The removable HDD 1126 records audio data ripped from the CD 1101, and the audio data is managed by use of the contents data structure described above.

In the removable HDD 1126, as described above, a plurality of music contents (MC30₁, 30₂ and the like) are recorded as individual files.

The modem 1128 is a communication device for connecting the music recorder 1000 (the controller 1116), a contents server 1132 and a metadata server 1134 via the Internet 1130 so as to communicate with each other.

Note that the music recorder 1000 can also include a communication device other than the modem 1128, for example, a media converter and the like, based on a communication line used for connection with the Internet 1130.

(Operation of Contents Data Recorder)

Next, description will be given of operations of the music recorder 1000 (the contents data recorder) according to the example described above.

(1) Initialization of Removable HDD

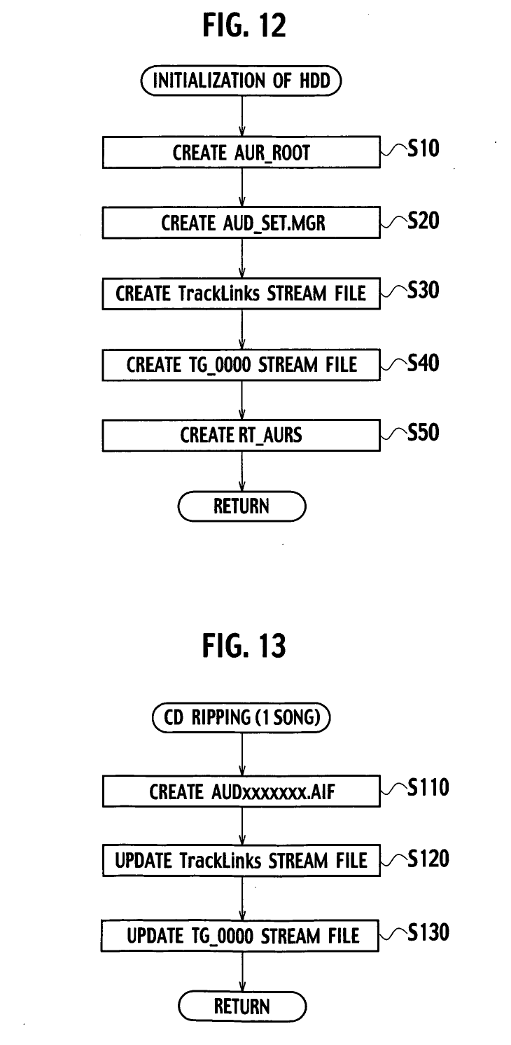

FIG. 12 shows an initialization processing flow for the removable HDD 1126 connected to the music recorder 1000.

As shown in FIG. 12, in Step S10, the music recorder 1000 creates an AUR_ROOT directory.

In Step S20, the music recorder 1000 creates an AUD_SET.MGR file. Specifically, fields included in the AUD_SET.MGR file are set as described below.
Flag=0
Num of UIE TGs=1
UIE TG ID (1)=0000 (ASCII)
Track Link Location=“./PROG_SET.MGR#TrackLinks”
Number of Track Groups=1
Maximum Track Group ID=0000

In Step S30, the music recorder 1000 creates a TrackLinks stream file. Specifically, fields included in the TrackLinks stream file are set as described below.
Number of Track Links=0
Number of Valid Track Links=0

In Step S40, the music recorder 1000 creates a TG_{—}0000 stream file. Specifically, fields included in the TG_{—}0000 stream file are set as described below.
TG Specific Structure TYPE=0x00
TG Flag=0x02
TG Specific Structure Name=“Track Base”
Link Count=0
Number of elements=0

In Step S50, the music recorder 1000 creates a RT_AURS directory.

(2) CD Ripping (1 Song)

FIG. 13 shows a flow of ripping audio data for 1 song from music contents (audio data) included in the CD 1101 (see FIG. 11) and recording the data in the removable HDD 1126.

As shown in FIG. 13, in Step S110, the music recorder 1000 creates an AUDxxxxxxx.AIF file based on the audio data included in the CD 1101. Specifically, fields included in the AUDxxxxxxx.AIF file are set as described below. Note that, in the fields having no concrete contents among the following fields, appropriate data according to contents of the AUDxxxxxxx.AIF file are described.
Number of Tracks=1
AUD Flag
Playback Time
File Size
Audio Format=(AAC)
Bit rate
File Created Date
Character Set (Unicode)
MetaDataFile Format
License Flag
License File Location

In Step S120, the music recorder 1000 updates the contents of the TrackLinks stream file. Specifically, the music recorder 1000 updates the contents of the TrackLinks stream file as described below. Note that, in the fields having no concrete contents among the following fields, appropriate data according to the contents of the AUDxxxxxxx.AIF file are described.
Number of Track Links=n+1
Number of Valid Track Links=n+1
Add TL Structure
TL Specific Structure TYPE=0x1
TL Flag
Link Count=1 (from TG_{—}0000)
Music Content ID=xxxxxxx
MetaData
My Rate Info
Last Accessed Time
Playback Counter
Resume Point

In Step S130, the music recorder 1000 updates the contents of the TG_{—}0000 stream file. Specifically, the music recorder 1000 updates the contents of the TG_{—}0000 stream file as described below.
Number of elements=n+1
Add element ID
   (3) CD Ripping (Music Album)

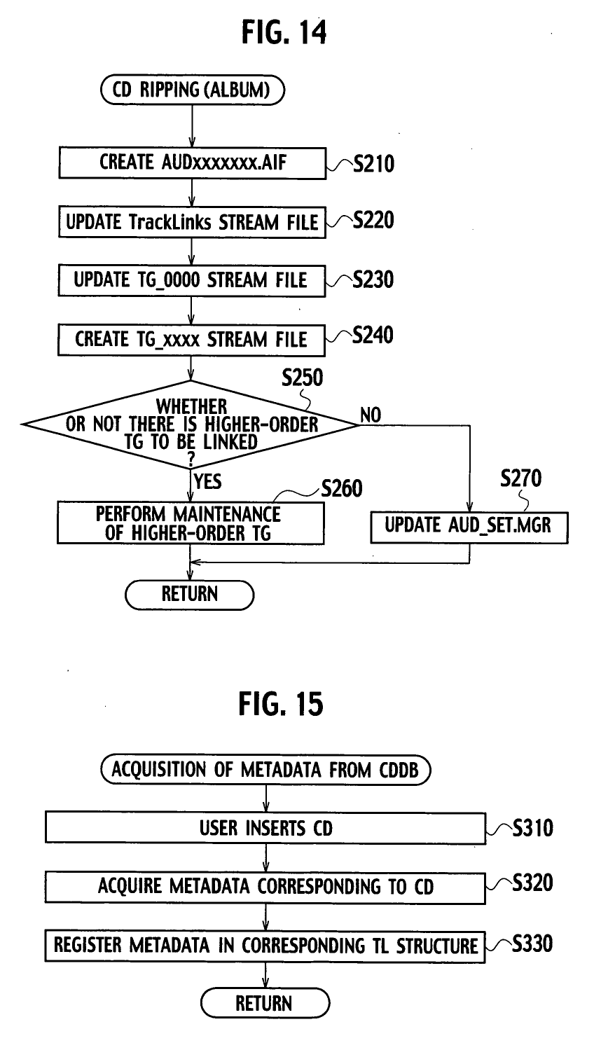

FIG. 14 shows a flow of ripping audio data formed of a plurality of songs from music contents (audio data) included in the CD 1101 and recording the data in the removable HDD 1126.

As shown in FIG. 14, in Step S210, the music recorder 1000 creates an AUDxxxxxxx.AIF file based on the audio data included in the CD 1101. Specifically, fields included in the AUDxxxxxxx.AIF file are set as described below. Note that, in the fields having no concrete contents among the following fields, appropriate data according to contents of the AUDxxxxxxx.AIF file are described.
Number of Tracks=m (music album contains m songs)
AUD Flag
Playback Time
File Size
Audio Format=(AAC)
Bit rate
File Created Date
Character Set (Unicode)
MetaDataFile Format
License Flag
License File Location

In Step S220, the music recorder 1000 updates the contents of the TrackLinks stream file. Specifically, the music recorder 1000 updates the contents of the TrackLinks stream file as described below. Note that, in the fields having no concrete contents among the following fields, appropriate data according to the contents of the AUDxxxxxxx.AIF file are described.
Number of Track Links=n+m
Number of Valid Track Links=n+m
Add m TL Structures

In Step S230, the music recorder 1000 updates the contents of the TG_{—}0000 stream file. Specifically, the music recorder 1000 updates the contents of the TG_{—}0000 stream file as described below.
Number of elements=n+m
Add element ID (m)

In Step S240, the music recorder 1000 creates a TG_xxxx stream file. Specifically, fields included in the TG_xxxx stream file are set as described below.
TG Specific Structure TYPE=0x01
TG Flag=0x03
TG Specific Structure Name=Album Title
Link Count=0
Number of elements=m
element ID: Add m IDs
Add “1” to Link Count included in TL Structure of each element

In Step S250, the music recorder 1000 determines whether or not there is a higher-order TG (for example, TG10_{A} shown in FIG. 10) to which the TG_xxxx stream file created in Step S240 is linked.

If there is the higher-order TG to which the TG_xxxx stream file is linked (Yes in Step S250), the music recorder 1000 executes maintenance for the higher-order TG in Step S260. To be more specific, the following maintenance is executed.
Number of elements=n+1
element ID: Add xxxx portion of added TG_xxxx stream file

If there is no higher-order TG to which the TG_xxxx stream file is linked (No in Step S250), the music recorder 1000 updates the contents of the AUD_SET.MGR file in Step S270. To be more specific, the music recorder 1000 updates the contents of the AUD_SET.MGR file as described below.
Flag=0
Num of UIE TGs=2
UIE TG ID (2)=xxxx (ASCII)
Number of Track Groups=2
UIE TG ID (2) Name=Album Title
Maximum Track Group ID=xxxx

The operation in the case where the music contents included in the CD 1101 are ripped by the music recorder 1000 has been described above. Meanwhile, the music recorder 1000 can also download music contents stored in the contents server 1132 connected thereto via the Internet 1130 and record the contents in the removable HDD 1126.

(4) Acquisition of Metadata from CDDB

FIG. 15 shows a flow of acquiring metadata related to music contents from a CDDB.

As shown in FIG. 15, in Step S310, a user inserts the CD 1101 into the CD drive 1102 (see FIG. 11).

When the CD 1101 is inserted into the CD drive 1102 (see FIG. 11), in Step S320, the music recorder 1000 acquires metadata corresponding to the CD 1101 from the metadata server 1134.

To be more specific, the music recorder 1000 acquires metadata management information in the AUDxxxxxxx.AIF file and registers metadata in a MetaData stream file based on the acquired metadata management information. Note that, according to need, the music recorder 1000 changes a character code used for the metadata.

In Step S330, the music recorder 1000 registers metadata in a corresponding TL structure (see Table 8). If the metadata to be registered is longer than a field length, the music recorder 1000 deletes a portion of the metadata, which cannot be described in the field.

(5) Playback (Title Search/Metadata Display)

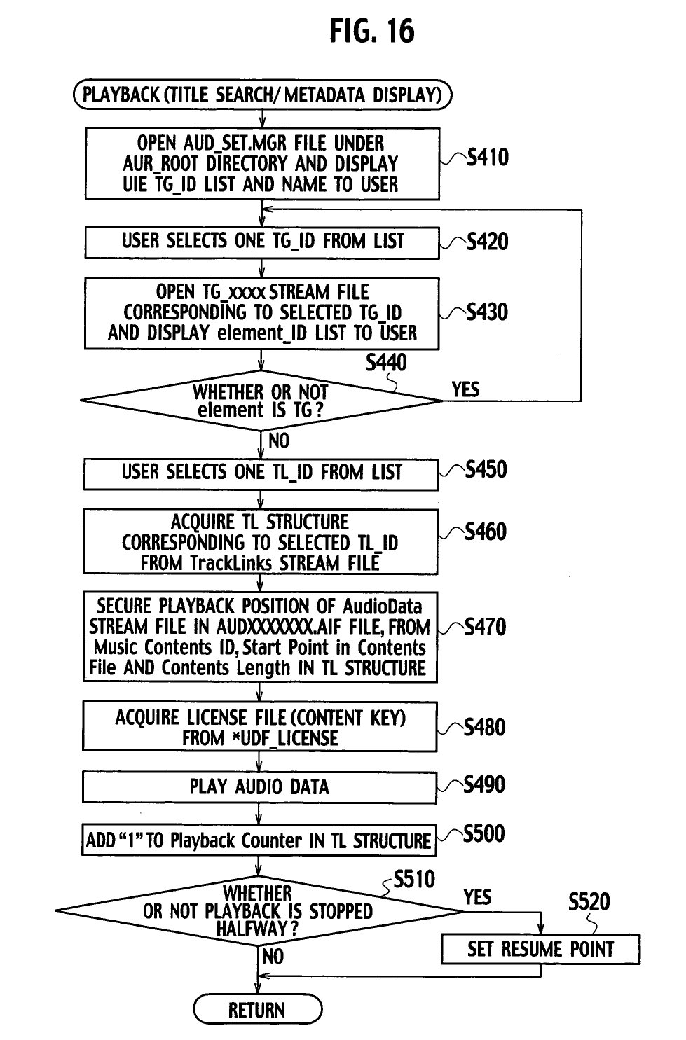

FIG. 16 shows a flow of playing music contents (audio data) included in the removable HDD 1126.

As shown in FIG. 16, in Step S410, the music recorder 1000 opens an AUD_SET.MGR file positioned under an AUR_ROOT directory, and then displays a list of UIE TG_IDs and a name thereof to a user.

In Step S420, the user selects one TG_ID from the list of UIE TG_IDs.

In Step S430, the music recorder 1000 opens a TG_xxxx stream file corresponding to the selected TG_ID, and displays a list of element_IDs to the user.

In Step S440, the music recorder 1000 determines whether or not the element is a TG.

If the element is the TG (Yes in Step S440), the music recorder 1000 repeats the processing from Step S420. If the element is not the TG, that is, if the element is a TL (No in Step S440), in Step S450, the user selects one TL_ID from the list of element_IDs.

In Step S460, the music recorder 1000 acquires a TL structure corresponding to the selected TL_ID from a TrackLinks stream file.

In Step S470, the music recorder 1000 secures a playback position of an AudioData stream file included in an AUDxxxxxxx.AIF file, from “Music Contents ID,” “Start Point in Contents File” and “Contents Length” in the acquired TL structure.

In Step S480, the music recorder 1000 acquires a license file (a content key) from a *UDF_LICENCE secure stream file.

In Step S490, the music recorder 1000 decrypts and plays audio data included in the AudioData stream file by use of the acquired content key.

In Step S500, the music recorder 1000 adds “1” to Playback Counter in the TL structure. Note that timing when “1” is added to Playback Counter may be either the time when playback is started or the time when playback is finished.

In Step S510, the music recorder 1000 determines whether or not playback of the audio data, that is, the music contents is stopped halfway.

If the playback of the music contents is stopped halfway (Yes in Step S510), in Step S520, the music recorder 1000 sets a resume point for a position where the playback is stopped.

(6) Playlist Creation (TG)

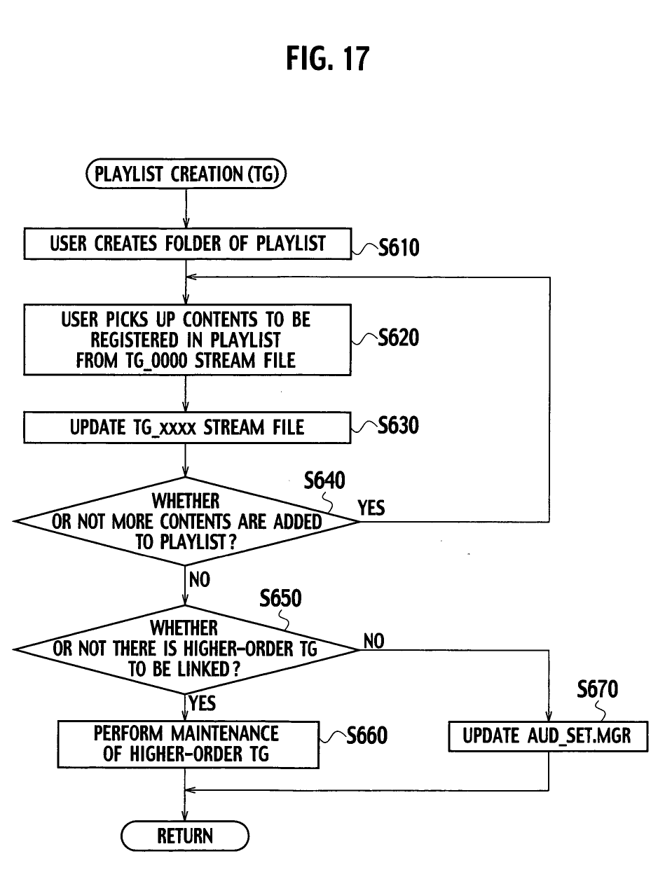

FIG. 17 shows a flow of creating a playlist (TG).

As shown in FIG. 17, in Step S610, a user creates a folder of a playlist. When the folder of the playlist is created by the user, the music recorder 1000 generates a TG_xxxx stream file. To be more specific, fields included in the TG_xxxx stream file are set as described below.
TG Specific Structure TYPE=0x02
TG Flag=0x03
TG Specific Structure Name=Playlist Title
Link Count=0
Number of elements=0

In Step S620, the user picks up contents to be registered in the playlist from a TG_{—}0000 stream file.

In Step S630, the music recorder 1000 updates the contents of the TG_xxxx stream file. Specifically, the music recorder 1000 updates the contents of the TG_xxxx stream file as described below.
Number of elements=n+1
element ID: Add selected TL_ID
Add “1” to Link Count included in TL Structure of each element

In Step S640, the music recorder 1000 determines whether or not there are more contents to be added to the playlist.

If there are more contents to be added to the playlist (Yes in Step S640), the user repeats the processing from Step S620.

If there are no more contents to be added to the playlist (No in Step S640), in Step S650, the music recorder 1000 determines whether or not there is a higher-order TG (for example, TG10_{A} shown in FIG. 10) to which the TG_xxxx stream file updated in Step S630 is linked.

If there is the higher-order TG to which the TG_xxxx stream file is linked (Yes in Step S650), the music recorder 1000 executes maintenance for the higher-order TG in Step S660. To be more specific, the same maintenance as that in Step S260 is executed.

If there is no higher-order TG to which the TG_xxxx stream file is linked (No in Step S650), the music recorder 1000 updates the contents of the AUD_SET.MGR file in Step S670. To be more specific, the music recorder 1000 updates the contents of the AUD_SET.MGR file as in the case of Step S270.

Note that, when the music recorder 1000 generates the TG_xxxx stream file, as a simple assignment method for the “xxxx” portion, the following method is used. Specifically, with reference to “Maximum Track Group ID” field (see Table 6), a value obtained by adding “1” to a current maximum value is assigned, and, at the same time, a value obtained by adding “1” to a current maximum value is also assigned in “Maximum Track Group ID” field.

Moreover, as another assignment method, there is the following method. Specifically, all TG_IDs are searched, and, if there is a missing number (for example, if the number is once generated and deleted thereafter), the number is assigned. In this case, if there is no missing number, as described above, a value obtained by adding “1” to a current maximum value is assigned, and, at the same time, a value obtained by adding “1” to a current maximum value is also assigned in “Maximum Track Group ID” field.

In other words, in the simple assignment method, it is not required to search all the TG_IDs. Thus, assignment processing for the “xxxx” portion can be executed at higher speed.

(7) Sorting of List by Metadata

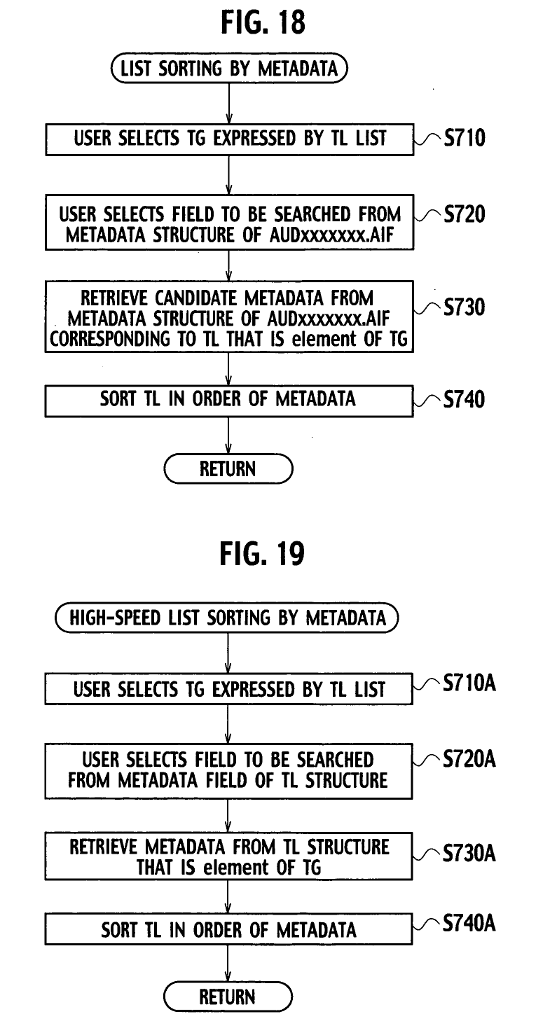

FIG. 18 shows a flow of sorting a list by metadata. As shown in FIG. 18, in Step S710, a user selects a TG expressed by a list of TLs.

In Step S720, the user selects a field that he/she wishes to search from a MetaData stream file (a metadata structure) which is included in an AUDxxxxxxx.AIF file.

In Step S730, the music recorder 1000 retrieves candidate metadata from the MetaData stream file in the AUDxxxxxxx.AIF file corresponding to TLs which are elements of the TG. In Step S740, the music recorder 1000 sorts the relevant TLs in the order of the metadata.

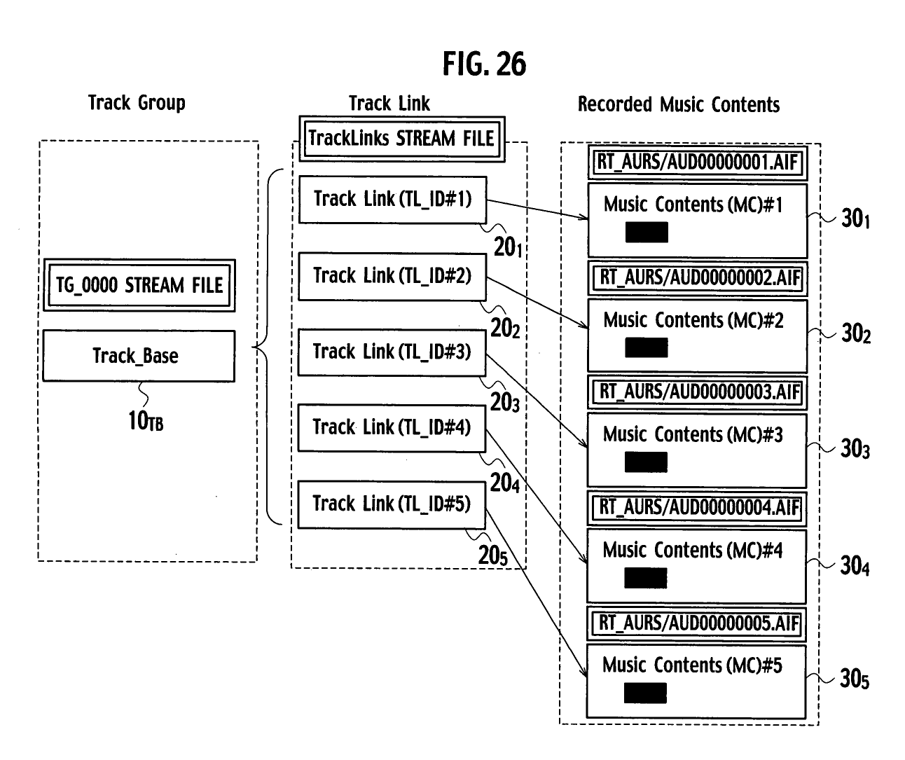

To be more specific, as shown in FIG. 26, in the case where the list is sorted by the metadata from Track_Base (TG10_{TB}) including 5 tracks (TL20₁ to 20₅ and MC30₁ to MC30₅), the music recorder 1000 executes the following processing for the TLs having TL_ID #1 to TL_ID #5.

(i) The MetaData stream file which belongs to the AUDxxxxxxx.AIF file is opened for the TLs (TL20₁ to 20₅) having TL_ID #n (n=1 to 5).

(ii) The number of bytes from a top of the MetaData stream file to a top of “Genre” field is calculated (corresponding to calculation of 1+a+1+b+1+c+1+d in Table 26).

(iii) A value (=e) of “Length of Genre” field is acquired.

(iv) Data described in “Genre” field which follows “Length of Genre” field is acquired.

(v) A list of TL_IDs and Genre data is compared with the already acquired list (for example, a list related to TL_ID #1 and TL_ID #2 in the case of TL_ID #3) and is sorted in alphabetical order (in the order of the Japanese syllabary in the case of Japanese).

As to the TLs (TL20₁ to 20₅) having TL_ID #1 to TL_ID #5, the music recorder 1000 which has executed the processing (i) to (v) described above displays the contents of the list in the order of the sorted TL_IDS.

(8) High-Speed Sorting of List by Metadata

FIG. 19 shows a flow of high-speed sorting of a list by metadata. As shown in FIG. 19, in Step S710A, a user selects a TG expressed by a list of TLs.

In Step S720A, the user selects a field that he/she wishes to search from a metadata field which is defined by a TL structure.

In Step S730A, the music recorder 1000 retrieves candidate metadata from the TL structure corresponding to TLs which are elements of the TG. In Step S740A, the music recorder 1000 sorts the relevant TLs in the order of the metadata.

Specifically, in the list sorting method by the metadata, which is shown in FIG. 18, it is required to retrieve the contents by opening the MetaData stream file (metadata structure) included in the AUDxxxxxxx.AIF file. On the other hand, in the list sorting method by the metadata, which is shown in FIG. 19, use of the TL structure (see Table 8) having a fixed length of 324 bytes makes it possible to execute sorting at higher speed.

To be more specific, as shown in FIG. 26, in the case where the list is sorted at high speed by the metadata from Track_Base (TG10_{TB}) including 5 tracks (TL20₁ to 20₅ and MC30₁ to MC30₅), the music recorder 1000 executes the following processing by opening the TrackLinks stream file.

(i) A top position of “Genre” field having TL_ID #1 is acquired. To be more specific, it is recognized that the top position of “Genre” field having TL_ID #1 is at the 210^{th} byte from the top of the TrackLinks stream file (data of the TL structure related to TL_ID #1 is started from the 8^{th} byte in Table 7, and “Genre” field is started from the 202^{nd} byte in Table 8).

(ii) Data described in “Genre” field is acquired, and a list of TL_IDs and Genre data is stored.

(iii) A top position (the 534^{th} byte (210+324 bytes, see Tables 7 and 8)) of “Genre” field having TL_ID #2 is acquired. Similarly, top positions of TL_IDs #3, #4 and #5 are set to (210+2×324)ₜₕ byte, (210+3×324)^{th} byte and (210+4×324)^{th} byte, respectively.

(iv) A list of TL_IDs and Genre data is compared with the already acquired list (for example, a list related to TL_ID #1 and TL_ID#2 in the case of TL_ID #3) and is sorted in alphabetical order (in the order of the Japanese syllabary in the case of Japanese).

As to the TLs (TL20₁ to 20₅) having TL_ID #1 to TL_ID #5, the music recorder 1000 which has executed the processing (i) to (iv) described above displays the contents of the list in the order of the sorted TL_IDs.

(9) High-Speed Retrieval of List by Metadata

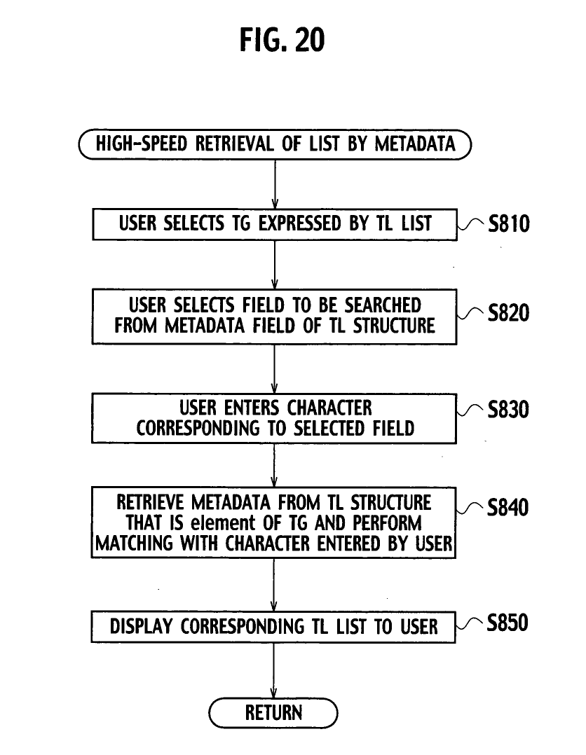

FIG. 20 shows a flow of high-speed retrieval of a list by metadata. As shown in FIG. 20, in Step S810, a user selects a TG expressed by a list of TLs.

In Step S820, the user selects a field that he/she wishes to search from a metadata field which is defined by a TL structure.

In Step S830, the user enters characters corresponding to the selected field.

In Step S840, the music recorder 1000 retrieves metadata from the TL structure corresponding to TLs which are elements of the TG, and executes matching with the characters entered by the user. In Step S850, the music recorder 1000 displays a list of the relevant TLs to the user.

The TL structure (see Table 8) having a fixed length of 324 bytes is also used in this retrieval method. Thus, compared with the case where the MetaData stream file is opened, retrieval can be executed at higher speed.

(10) Setting of Resume Point

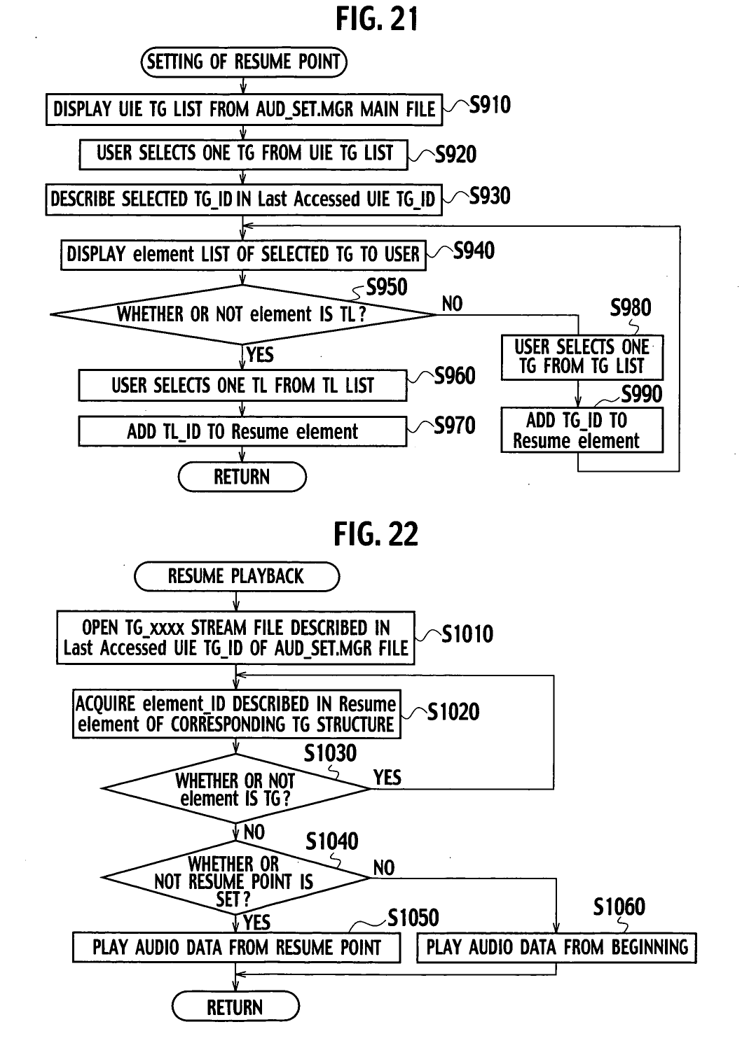

FIG. 21 shows a flow of setting a resume point. As shown in FIG. 21, in Step S910, the music recorder 1000 displays to a user a list of UIE TGs from an AUD_SET.MGR file.

In Step S920, the user selects one TG from the UIE TG list. In Step S930, the music recorder 1000 describes a selected TG_ID in “LastAccessed UIETG_ID” field. Moreover, the music recorder 1000 describes the time when the TG_ID is described in “Last Accessed UIE TG_ID recorded date.”

In Step S940, the music recorder 1000 displays an element list of the selected TG to the user.

If the element is a TG (No in Step S950), the user selects one TG from the TG list in Step S980. In Step S990, the music recorder 1000 adds the TG_ID to “Resume element.”

If the element is a TL (Yes in Step S950), in Step S960, the user selects one TL from the TL list. In Step S970, the music recorder 1000 adds the TL_ID to “Resume element.”

Thereafter, the music recorder 1000 plays the audio data based on the TL structure corresponding to the selected TL_ID (see the processing after Step S470 in FIG. 16).

(11) Resume Playback

FIG. 22 shows a flow of playing audio data based on a resume point (resume playback). As shown in FIG. 22, in Step S1010, the music recorder 1000 opens a TG_xxxx stream file corresponding to a TG_ID described in “Last Accessed UIETG_ID” in an AUD_SET.MGR file.

In Step S1020, the music recorder 1000 acquires an element_ID described in “Resume element” of the relevant TG.

In Step S1030, the music recorder 1000 determines whether or not the element is a TG. If the element is the TG (Yes in Step S1030), the music recorder 1000 repeats the processing from Step S1020.

If the element is a TL (No in Step S1030), in Step S1040, the music recorder 1000 determines whether or not a resume point is set.

If the resume point is set (Yes in Step S1040), in Step S1050, the music recorder 1000 plays audio data from the resume point. On the other hand, if the resume point is not set (No in Step S1040), in Step S1060, the music recorder 1000 plays the audio data from the beginning of a song (or a music album).

Note that, in the case where resume point setting is set to be an optional feature, as described above, “Resume Support Flag” in the AUD_SET.MGR file is used. A music recorder or the like (a contents data recorder) which supports resuming function records 1b at start-up (when a power is turned on, or the like). On the other hand, a music recorder or the like which does not support resuming function records 0b at start-up.

Moreover, in the case where the audio data is played by another music recorder or the like after the removable HDD 1126 (removable recording medium) is moved, the another music recorder or the like first reads contents of “Resume Support Flag” in the AUD_SET.MGR file. Thereafter, resume playback is performed if a value is 1b, and resume playback is not performed if the value is 0b.

(12) Title Deletion

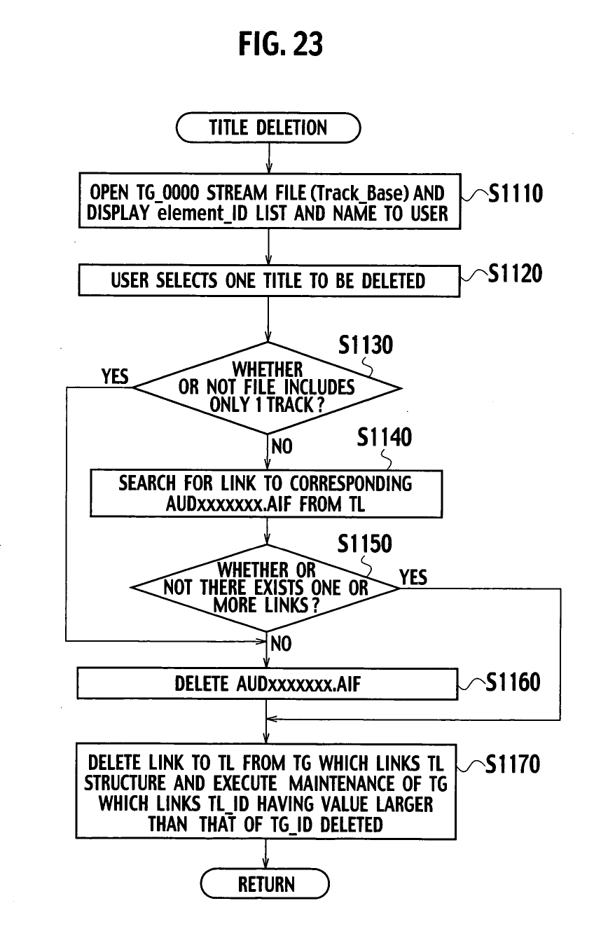

FIG. 23 shows a flow of deleting a title corresponding to music contents (audio data). As shown in FIG. 23, in Step S1110, the music recorder 1000 opens a TG_{—}0000 stream file (Track_Base (TG10_{TB})) and displays a list of element_IDs and a name thereof to a user.

In Step S1120, the user selects one title to be deleted. In Step S1130, the music recorder 1000 determines whether or not an AUDxxxxxxx.AIF file linked to a TL of the title is formed of only 1 track.

If the AUDxxxxxxx.AIF file is formed of only 1 track (Yes in Step S1130), in Step S1160, the music recorder 1000 deletes the AUDxxxxxxx.AIF file.

If the AUDxxxxxxx.AIF file is not formed of only 1 track (No in Step S1130), that is, if the AUDxxxxxxx.AIF file is formed of a plurality of songs, in Step S1140, the music recorder 1000 searches for a link to the AUDxxxxxxx.AIF file from the TL.

In Step S1150, the music recorder 1000 determines whether or not there exists one or more links to the AUDxxxxxxx.AIF file from the TL.

If there exists one or more links to the AUDxxxxxxx.AIF file (Yes in Step S1150), the music recorder 1000 executes processing of Step S1170 without deleting the AUDxxxxxxx.AIF file.

On the other hand, if there exist absolutely no links to the AUDxxxxxxx.AIF file (No in Step S1150), in Step S1160, the music recorder 1000 deletes the AUDxxxxxxx.AIF file.

In Step S1170, the music recorder 1000 deletes a TL structure associated with the AUDxxxxxxx.AIF file and, at the same time, deletes links to the TL from a TG which links the TL structure. To be more specific, since the number of links from the TG is described in “Link Count” in the TL structure, the music recorder 1000 deletes the links to the TL based on “Link Count.”

Moreover, in the case where a TL structure is deleted from a TrackLinks stream file, other TL_IDs become smaller by “1,” respectively (since the TL_IDs are arranged in order). Thus, for all TGs, it is required to perform maintenance of the TL_ID of the deleted TL and TL_IDs of TLs after the TL.

Specifically, the music recorder 1000 executes maintenance of a TG which links a TL_ID having a value larger than that of the deleted TL_ID. To be more specific, the values of the TL_IDs are reduced by “1,” respectively.

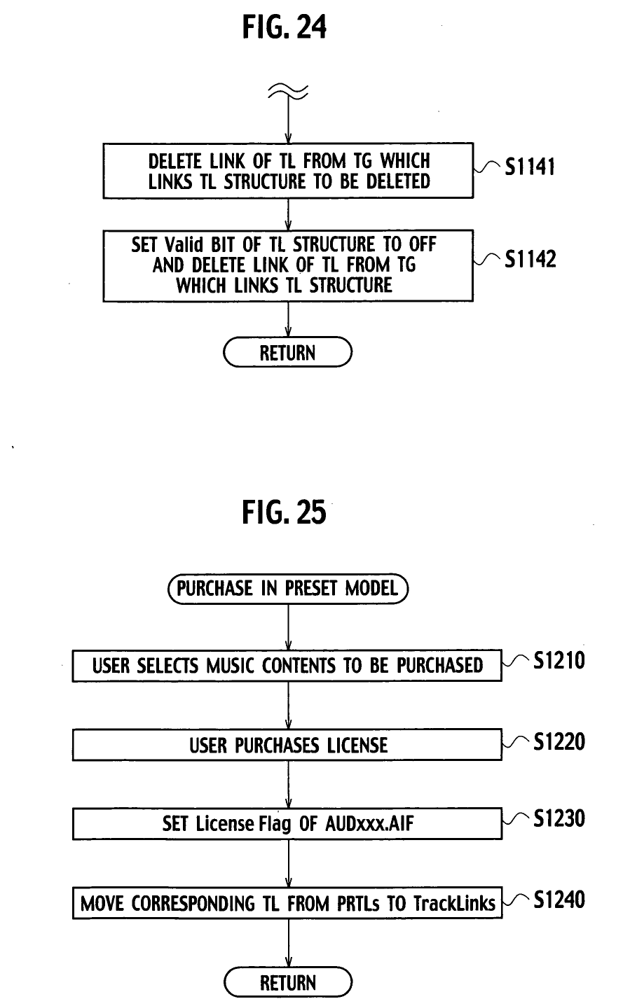

FIG. 24 shows a modified part of the “title deletion” flow shown in FIG. 23. Processing of Steps S1141 and S1142 shown in FIG. 24 are executed instead of the processing of S1170 shown in FIG. 23.

In Step S1141, the music recorder 1000 deletes links of the TL from a TG which links a TL structure to be deleted.

In Step S1142, the music recorder 1000 sets a Valid bit of the TL structure to OFF, and deletes links to the TL from the TG which links the TL structure.

Note that, in this case, the above-described maintenance of the TL_ID is not required. Specifically, the TL_ID is not changed since the TL structure itself is not deleted. However, for the TG, maintenance of the deleted TL_ID is required. By use of this simple method, an area in which the Valid bit is set to OFF can be reused next time TLs are added.

(13) Purchase in Preset Model

FIG. 25 shows a flow of purchasing desired music contents by a user in a preset model in which encrypted music contents (audio data) are previously recorded in the removable HDD 1126.

In the preset model, audio data (AudioData stream files) are recorded in an AUDxxxxxxx.AIF file. Moreover, TLs are recorded in a PRTLs stream file for exclusive use in the preset model. The user obtains (purchases) the removable HDD 1126 in which the audio data or various files are recorded as described above.

In this state, the user cannot listen to the music contents (audio data) which are recorded in the removable HDD 1126. Thus, the user is required to go through purchase procedures. To be more specific, as shown in FIG. 25, in Step S1210, the user selects music contents that he/she will purchase by utilizing the high-speed retrieval (see FIG. 20) by the music recorder 1000 and the like.

In Step S1220, the user purchases a license (a content key and utilization conditions) for listening to the music contents. To be more specific, the user purchases the license by accessing the contents server 1132 and the like.

When the license is purchased by the user, in Step S1230, the music recorder 1000 sets “License Flag” that is license management information included in an AUDxxxxxxx.AIF file related to the purchased music contents. At the same time, the music recorder 1000 generates a *UDF_LICENCE secure stream file.

In Step S1240, the music recorder 1000 moves the TL from a PRTLs stream file to a TrackLinks stream file (for details, see the above description related to FIGS. 7 and 8). Note that a title in the PRTLs stream file is deleted by use of the simple method shown in FIG. 24.

(Operation/Effect)

According to the embodiment and example described above, a user who utilizes audio data such as music contents can more easily and promptly perform retrieval and playback of the music contents by use of an AUD_SET.MGR file including track link information and metadata management information (MetaData stream files). Thus, convenience in handling the music contents can be improved.

### Other Embodiments

As described above, the contents of the present invention have been disclosed through one embodiment of the present invention. However, it should be understood that the present invention is not limited to the description and drawings which constitute a part of this disclosure. From this disclosure, various alternative embodiments will become apparent to those skilled in the art.

For example, in the above-described embodiment of the present invention, the description was given by taking the music contents (audio data) as an example. However, the present invention can be applied to not only the music contents but also contents of still pictures or moving pictures, for example.

Moreover, in the above-described embodiment of the present invention, the description was given by taking the removable HDD 1126 (removable recording medium) as an example. However, the present invention can be also applied to a hard disk drive (HDD) included in a contents data recorder and the like.

As described above, needless to say, the present invention includes various embodiments and the like which are not described here. Therefore, the technical scope of the present invention is determined only by the items specific to the invention according to the scope of claims appropriate based on the above description.

What is claimed is:

1. A contents data structure used in a contents data recording medium in which a plurality of pieces of contents data are recorded as individual files, comprising:
a link information segment which indicates at least positions and sizes of the contents data on the contents data recording medium;
a metadata segment which describes contents of the contents data and is used for retrieval of the individual files; and
a management file area which includes the link information segment and the metadata segment, wherein,
by use of the management file area, an access device which accesses the contents data recording medium retrieves the contents data.

2. The contents data structure of claim 1, wherein the management file area includes a license management information segment which allows the access device to play the contents data.

3. A contents data recording medium in which a plurality of pieces of contents data are recorded as individual files, comprising:
link information which indicates at least positions and sizes of the contents data on the contents data recording medium;
metadata which describes contents of the contents data and is used for retrieval of the individual files; and
a management file which includes the link information and the metadata, wherein,
by use of the management file, an access device which accesses the contents data recording medium retrieves the contents data.

4. The contents data recording medium of claim 3, wherein the management file includes license management information which allows the access device to play the contents data.

5. A contents data recorder which records a plurality of pieces of contents data as individual files, comprising:
a link information generation unit which generates link information indicating at least positions and sizes of the contents data on the contents data recording medium;
a meta-information acquisition unit which acquires metadata describing contents of the contents data and being used for retrieval of the individual files;
a management file generation unit which generates a management file including the link information and the metadata; and
a contents retrieval unit which retrieves the contents data by use of the management file.

6. The contents data recorder of claim 5, further comprising:
a contents playback unit which plays the contents data based on the license management information, wherein
the management file includes license management information which allows playback of the contents data.
